(19) United States
(12) Patent Application Publication
(10) Pub. No.: US 2009/0310461 A1
(43) Pub. Date: Dec. 17, 2009

(54) LIGHT SOURCE DRIVE, OPTICAL PICKUP UNIT WHEREIN THE LIGHT SOURCE DRIVE IS INSTALLED, OPTICAL DISC DRIVE WHEREIN THE OPTICAL PICKUP UNIT IS INSTALLED, AND INFORMATION TERMINAL WHEREIN THE OPTICAL DISC DRIVE IS INSTALLED

(75) Inventors: Yoshitatsu KAJIWARA, Fukuoka (JP); Tetsuya ARAKI, Fukuoka (JP); Toshihiro YAMASAKI, Fukuoka (JP)

Correspondence Address: GREENBLUM & BERNSTEIN, P.L.C., 1950 ROLAND CLARKE PLACE, RESTON, VA, 20191, US

(73) Assignee: Panasonic Corporation, Osaka (JP)

(21) Appl. No.: 12/481,988

(22) Filed: Jun. 10, 2009

(30) Foreign Application Priority Data
Jun. 11, 2008 (JP) 2008-152607

(51) Int. Cl. G11B 7/00; H05B 37/02

(52) U.S. Cl. 369/100; 315/291; G9B/7

(57) ABSTRACT

In a voltage conversion section 154 for converting a supply voltage from a battery 206 for driving a light source 71 into a supply voltage to an LD drive section 116, the supply voltage to the LD drive section 116 is controlled from a preset initial voltage to a voltage resulting from adding a voltage set within a given range in which the lower limit is the voltage at which the power loss of a transistor of the LD drive section 116 becomes the lowest in a current range in which the light source can be driven in a predetermined light quantity and the drive voltage of the light source.

### BACKGROUND

1. Field of the Invention

This invention relates to a light source drive for driving mainly with a portable battery such as a lithium ion battery, an optical pickup unit wherein the light source drive is installed, an optical disc drive wherein the optical pickup unit is installed, and a portable information device wherein the optical disc drive is installed.

2. Description of the Related Art

An optical disc started with playback and record of a compact disc (CD) and higher density of the optical disc has advanced from a DVD (Digital Versatile Disc) that can play back and record video to a Blu-ray disc (BD) that can play back and record video with a higher degree of definition, and the like.

Usually, a conventional optical disc drive for playing back and recording the discs is connected to the internal power supply or an external bus of USB (Universal Serial Bus), etc., of a personal computer or any other information processing apparatus and power is supplied to the optical disc drive at a fixed voltage of 5 V or 12 V. The reason why power at the fixed voltage can be supplied is that usually a personal computer or any other information processing apparatus receives power supply from an AC outlet and the power supply is semipermanent and voltage is converted in accordance with the power supply specification for a connection device of the optical disc drive, etc. In addition, a large restriction is not put on power consumption.

If the apparatus is adapted to be able to operate with a portable battery such as a lithium ion battery and a measure of restriction is put on power consumption, the supply voltage of the battery used for the apparatus is usually about 10 V to 24 V; the capacity is also large and there is a comparative allowance for power supply to the connection device by voltage conversion.

FIG. 17 is a block diagram to show a related art; it shows the relationship among a light source 301 such as a laser diode (LD) for playing back and recording an optical disc in an optical disc drive adapted to be able to operate with a portable battery, a drive section 302 such as an LD driver mainly made up of transistors for driving the light source 301, and a voltage conversion (power supply) section 303 such as a DC/DC converter for supplying power to the optical disc drive including the light source 301 and the drive section 302. Although not shown in the figure, the voltage conversion section 303 receives power supply from an AC adapter connected to a battery or an AC power supply. Usually, the light quantity of the light source 301 varies depending on the temperature and the voltage. Thus, a light quantity monitor section 304 monitors the light quantity of the light source and if the light quantity varies, a light quantity control section 305 controls the drive section 302 and performs feedback control of the applied voltage to the light source 301 so that the light quantity becomes a predetermined light quantity. (Refer to patent document 1.)

The drive voltage of the light source 301 used to play back and record an optical disc shown in FIG. 17 involves an individual difference and further, in one, the drive voltage also changes with the ambient temperature and variation with time. The drive voltage is usually about 2.3 V to 2.6 V and is 3 V or less at the maximum for an infrared or red laser diode used to play back and record a CD/DVD. It is about 3.2 V to 6.8 V and is 7 V or less at the maximum for a blue laser diode used for a BD, etc. Thus, in such an information processing apparatus that can operate with a portable battery, the supply voltage from the voltage conversion section 303 to the light source 301 and the drive section 302 is lowered or boosted for use to a fixed voltage to such an extent that the laser diode can be driven by voltage conversion means such as a DC/DC converter (not shown) in the voltage conversion section 303.

Patent document 1: JP-A-2004-146050

However, when a smaller optical disc than ever makes its market debut and accordingly an optical disc drive that can play back and record the optical disc is miniaturized and is installed in a palm-size portable information device such as a PDA, a portable CD/DVD player, a mobile telephone, or a portable gaming machine, for example, the following problem occurs in the configuration in the related art described above.

The supply voltage of a lithium ion battery of one cell used in the palm-size portable information device is a low voltage as 2.7 V to 4.2 V and the capacity is also small as 1,100 mAhh to 1,800 mAh at the best. When the light source used to play back and record an optical disc is an infrared or red laser diode, if the drive voltage of the laser diode and the supply voltage of a lithium ion battery move up and down, the supply voltage of the battery is higher than the drive voltage of the laser diode in the actual drive time. Thus, it is a common practice to lower the voltage to a fixed voltage by a step-down type DC/DC converter as voltage conversion means and supply drive voltage. However, if the light source is a blue laser diode, the higher-lower relationship between the supply voltage of the lithium ion battery and the drive voltage of the laser diode is replaced in the actual drive time. Therefore, to drive the blue laser diode as a light source of an optical disc drive in the palm-size portable information device, a method of boosting the supply voltage from the lithium ion battery to a fixed voltage equal to or greater than the maximum drive voltage of the laser diode by a step-up type DC/DC converter is adopted. Generally, the conversion efficiency of the step-up type DC/DC converter is lower than the conversion efficiency of the step-down type DC/DC converter about 10% or more and as compared with the infrared or red laser diode from the electric condition viewpoint, it can be the that it is hard to drive the blue laser diode stably for a long time.

If the voltage applied to the light source and the drive section is boosted to a fixed voltage all the time to drive the blue laser diode as before, waste occurs as described below: As described above, the drive voltage of the light source changes according to individual differences of light sources and further, in one light source, the drive voltage also changes with the ambient temperature and variation with time. To deal with the change, it is considered that the supply voltage to the light source and the drive section is determined considering the maximum drive voltage on the specification that the light source has and the supply voltage is boosted to a fixed voltage all the time. However, an occasion where the drive voltage becomes is very rare in the actual use of a laser diode driver (drive section) and in almost all cases, the difference between the actual drive voltage and the maximum drive voltage occurs and the difference, surplus power in the drive section is consumed as heat. This means that the power of the lithium ion battery is consumed wastefully and driving the blue laser diode stably for a long time is hindered. Consequently, the operable time of the portable information device is shortened.

### SUMMARY

The invention is intended for solving the problem in the related art and it is an object of the invention to decrease wasteful power consumption in a light source and a drive section, realize power saving of a battery such as a lithium ion battery, and ensure the operable time of an optical pickup unit, an optical disc drive, and a portable information device each wherein the light source and the drive section are installed as long as possible.

To accomplish the object, the invention is characterized by a light source drive having a light source; a light source drive section for driving the light source; and a voltage conversion section for converting a supply voltage from a battery for supplying power into a supply voltage to the light source drive section, wherein the voltage conversion section sets the supply voltage from the battery to the light source drive section to a preset initial voltage and then lowers the voltage to a predetermined voltage lower than the initial voltage, at which the light source drive section and the light source are driven.

According to the invention, wasteful power consumption in the light source and the drive section is decreased, power of a battery is not wastefully consumed, and the operable time can be ensured as long as possible.

### BRIEF DESCRIPTION OF THE DRAWINGS

FIG. 1 is a perspective view to show the appearance of an information playback apparatus in an embodiment of the invention;

FIG. 2 is a perspective view to show a state in which a top cover of the information playback apparatus in the embodiment of the invention is opened;

FIG. 3 is a perspective view to show the mechanism of a playback mechanical section in the embodiment of the invention;

FIG. 4 is a perspective view to show the configuration of an optical unit in the embodiment of the invention;

FIG. 5 is a configuration drawing to show details of the optical system of the optical unit in the embodiment of the invention;

FIG. 6 is a perspective view to show the structure of an actuator in the embodiment of the invention;

FIG. 7 is a block diagram to show the hardware configuration of the information playback apparatus in the embodiment of the invention;

FIG. 8 is an external view to show an example of a portable information terminal in which the information playback apparatus is installed in the embodiment of the invention;

FIG. 9 is an internal schematic drawing of a portable information terminal in the embodiment of the invention;

FIG. 10 is a block diagram to show the basic configuration of the embodiment of the invention;

FIG. 11 is a circuit diagram to show a configuration example of a voltage conversion section in the embodiment of the invention;

FIG. 12 is a circuit diagram to show a configuration example of an LD drive section and an LD drive voltage monitor section in the embodiment of the invention;

FIG. 13 is a drawing to show the relationship between collector-emitter saturation voltage and collector current characteristic of a PNP transistor of a light source drive semiconductor device in the embodiment of the invention;

FIG. 14 is a circuit diagram to show a configuration example of a voltage control section in the embodiment of the invention;

FIG. 15 is a drawing to describe the configuration of the invention shown in FIG. 10 in more detail;

FIG. 16 is a drawing of an oscilloscope to show time change of voltages occurring in the sections in FIG. 15; and

FIG. 17 is a block diagram to show a related art.

### DETAILED DESCRIPTION

An embodiment of the invention will be discussed with the accompanying drawings.

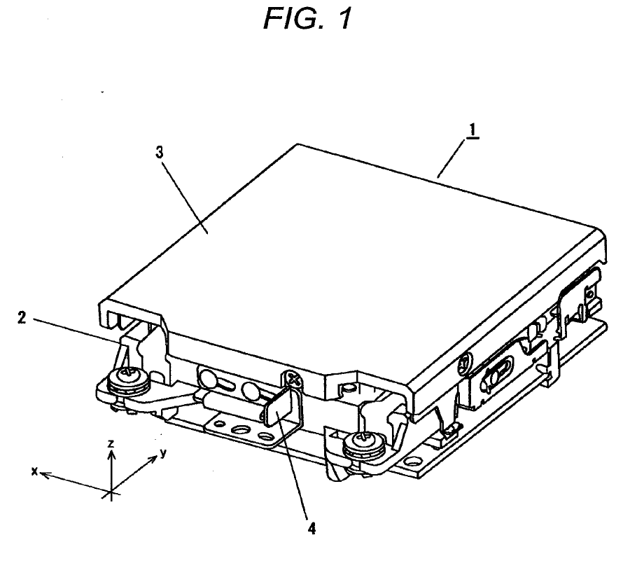

FIG. 1 is a perspective view to show the appearance of an information playback apparatus in the embodiment of the invention.

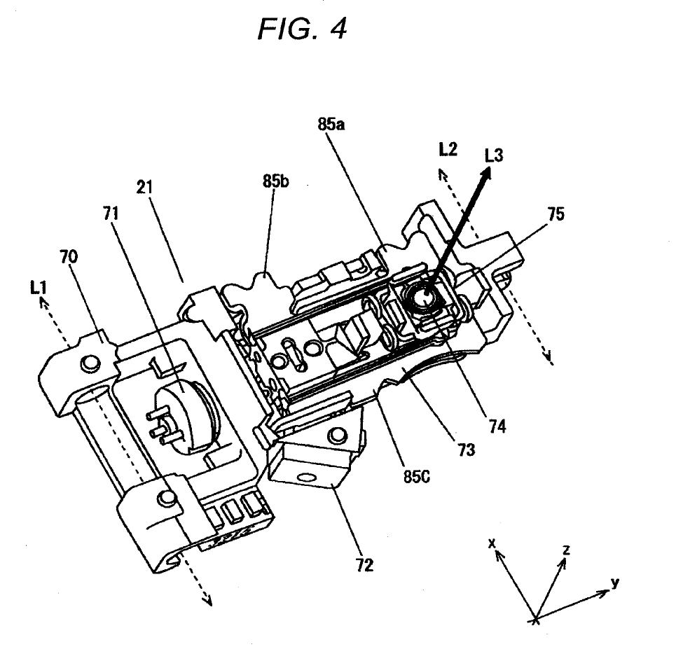

In the description to follow, an xyz coordinate system is used as the coordinate space in the figures. An x axis indicates a move direction of a carriage 70 (see FIG. 4) forming a part of an optical unit 21 (see FIG. 4) as described later in detail, namely, an axis from the inner periphery of an information record medium to the outer periphery, and the arrow direction indicates the outer peripheral direction of the information record medium. A y axis is an axis orthogonal to the x axis and the arrow direction indicates the emission direction of light from a light source 71 (see FIG. 4) installed in the optical unit 21 described later. A z axis is an axis orthogonal to the x axis and the y axis and is a normal to the surface of the information record medium. The arrow direction indicates the direction of light emitted from an object lens 74 (see FIG. 4) installed in a pickup 75 (see FIG. 4) described later to the information record medium. The arrow direction of the axes is defined as + and its opposite direction is defined as − in the description to follow. At this point in time, a laser diode (LD) can be named as a light source fitted for application as an information playback apparatus, but if a device is an optical device that can monitor a light quantity and can control the light quantity by current drive, the optical device can also be used as a light source of the invention.

In FIG. 1, numeral 1 denotes an information playback apparatus. The information playback apparatus 1 has a read function of information from an optical disc, etc., for example, housed in a cartridge with at least information already recorded thereon (hereinafter, called “disc-like record medium” if description is needed for a single body of optical disc, etc., housed in a cartridge is required. The disc-like record medium and the cartridge in which it is housed are collectively called “information record medium”). Numeral 2 denotes a playback mechanical section. The playback mechanical section 2 is made up of a mechanism for reading information recorded on an information record medium and hardware such as a circuit board involved in signal processing for controlling the mechanism and playing back information. Numeral 3 denotes a top cover made of a resin. The user can open the top cover 3 by operating a top cover opening lever 4 and can place and remove an information record medium in and from the information playback apparatus 1.

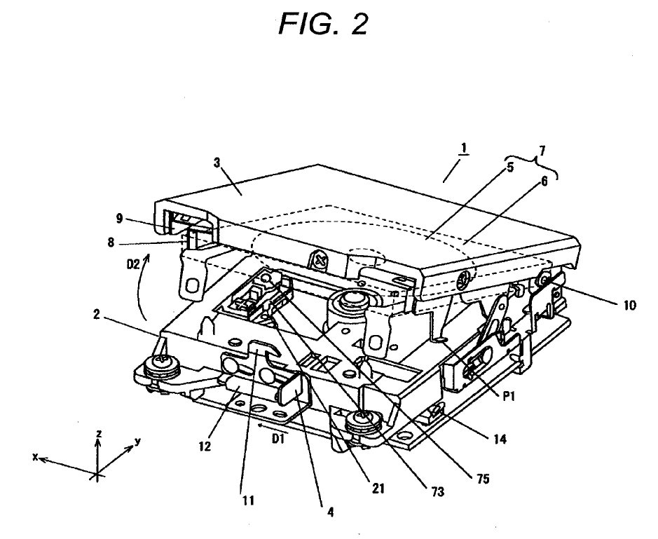

FIG. 2 is a perspective view to show a state in which the top cover 3 of the information playback apparatus 1 in the embodiment of the invention is opened.

In FIG. 2, numeral 5 denotes a disc-like record medium; in the embodiment, an optical disc having a small diameter of about 32 millimeters is used for applying the record medium to mobile application. Numeral 6 denotes a cartridge housing the disc-like record medium 5. The disc-like record medium 5 and the cartridge 6 make up an information record medium 7. Numeral 8 denotes an information record medium housing section. The user inserts or removes the information record medium 7 into or from the information record medium housing section 8. That is, in the information playback apparatus 1 of the embodiment, the information record medium 7 can be placed in and removed from the information record medium housing section 8.

Numeral 9 denotes a top chassis.

Numeral 10 denotes a housing section support part as the rotation center of opening/closing operation of the information record medium housing section 8 relative to the playback mechanical section 2. Numeral 11 denotes a hook and numeral 12 denotes a hook urging member. When the information record medium housing section 8 is closed, the hook 11 is secured by a securing member (not shown) provided on the top cover 3 for keeping the information record medium housing section 8 closed. On the other hand, if the user moves the top cover opening lever 4 in a direction D1, the hook 11 also moves in the direction D1 in association with the top cover opening lever 4 and is detached from the securing member (not shown) provided on the top cover 3 and the information record medium housing section 8, the top chassis 9, and the top cover 3 displace in a direction D2 with the housing section support part 10 as the support center, whereby the information record medium housing section 8 is exposed and is opened. When the user inserts the information record medium 7 into the exposed information record medium housing section 8 and presses the top cover 3 in the opposite direction to the direction D2, the information record medium housing section 8 moves in the direction D2 together with the top chassis 9 and becomes the closed state shown in FIG. 1.

Numeral 21 denotes an optical unit installing an optical system for reading information recorded on the information record medium 7 housed in the information record medium housing section 8. Further, the optical unit 21 is made up of a carriage (not shown) supported so as to be able to move in x axis ±direction along the record surface of the disc-like record medium 5 forming a part of the information record medium 7, namely, in the center direction and the outer periphery direction of the disc-like record medium 5, a pickup 75 for forming an image of light emitted from a light source (not shown) on the record surface of the disc-like record medium 5, an actuator 73 for controlling the position of the pickup 75 in z axis ±direction and x axis ±direction in real time so that the pickup 75 and the record surface maintain a predetermined positional relationship during the read operation, and the like, as described later in detail.

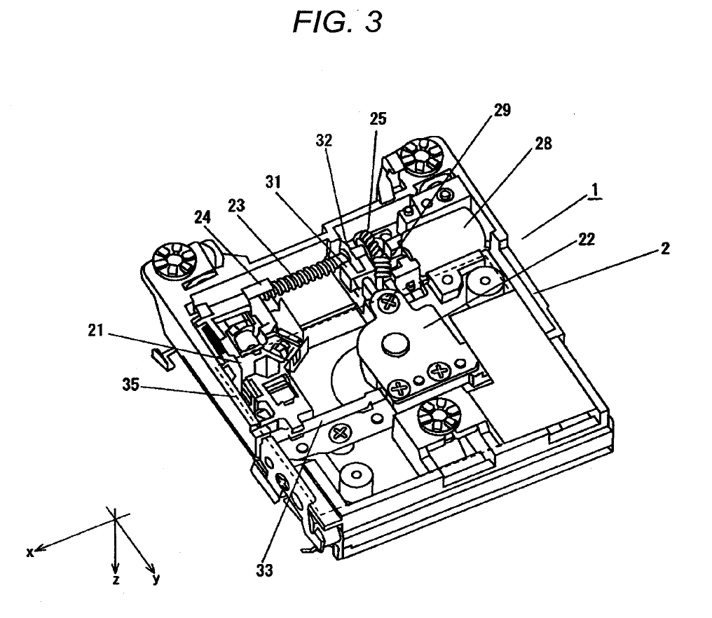

FIG. 3 is a perspective view to show the mechanism of the playback mechanical section 2 in the embodiment of the invention; the playback mechanical section 2 in FIG. 2 is viewed from the z axis −direction to the +direction.

In FIG. 3, numeral 21 denotes the optical unit for reading information recorded on the information record medium 7 (see FIG. 2) as described above. Numeral 22 denotes a spindle motor implemented as a brushless motor used as a power source for rotating and driving the information record medium 7, numeral 23 denotes a lead screw shaft threaded to move the optical unit 21 in the x axis ±direction, namely, to inner periphery, outer periphery position of the information record medium 7 (not shown in FIG. 3; see FIG. 2), numeral 24 denotes a rack plate spring for transmitting power from the lead screw shaft 23 to the optical unit 21, numeral 25 denotes a lead screw shaft gear fixed to the lead screw shaft 23, numeral 28 denotes a feed motor used as a power source for rotating the lead screw shaft 23, numeral 29 denotes a motor gear attached to a rotation shaft of the motor 28, and numeral 33 denotes a guide shaft for regulating and guiding the operation of the optical unit 21 to inner periphery, outer periphery position of an information record medium.

The feed motor 28 is driven in a predetermined direction, whereby the driving force is transmitted through the motor gear 29, the lead screw shaft gear 25, the lead screw shaft 23, and the rack plate spring 24 and the optical unit 21 is guided by the lead screw shaft 23 and the guide shaft 33 and is driven in the x axis ±direction.

Numeral 35 denotes a control section having various electronic components built in a glass epoxy board. Although the configuration of the hardware installed in the control section 35 is described later in detail, at least a CPU, work memory implemented as RAM, nonvolatile program memory implemented as ROM, etc., nonvolatile memory implemented as EEPROM, etc., storing the state of the information playback apparatus 1, and the like (not shown) are installed in the control section 35.

FIG. 4 is a perspective view to show the configuration of the optical unit 21 in the embodiment of the invention. The configuration of the optical unit 21 in the embodiment of the invention will be discussed below in detail with FIGS. 2 and 3 as well as FIG. 4:

In FIG. 4, numeral 70 denotes a carriage made according to aluminum diecasting, etc., for example, advantageous on working accuracy, forming a part of the optical unit 21. The carriage 70 is supported by the lead screw shaft 23 (see FIG. 3) placed on an L1 line and the guide shaft 33 placed on an L2 line along the x axis ±direction in the playback mechanical section 2 (see FIG. 3). The carriage 70 moves in the x axis ±direction with rotation of the lead screw shaft 23 (see FIG. 3) on the L1 line and the L2 line of the x axis ±direction and on extension lines and conveys the optical unit 21 to any desired position from the inner periphery to the outer periphery of the information record medium 7 (see FIG. 2).

Numeral 71 denotes a light source made of a bluish purple laser diode with wavelength λ=405 nm, for example; in the embodiment, a high output type with output=5 mW is adopted. The bluish purple laser of a short wavelength makes it possible to deal with playback of the information record medium 7 (see FIG. 2) having a high recording density. Numeral 72 denotes a light reception sensor implemented as a four-division sensor having four light reception faces shaped like four divided scares. The light reception sensor 72 detects light reflected from the record surface of the disc-like record medium 5 (see FIG. 2) forming a part of the information record medium 7 (see FIG. 2) and outputs ON/OFF information made of pits recorded on the information record medium 7 (see FIG. 2) and also outputs minute displacement error (tracking error) information in the x axis ±direction and minute displacement error (focus error) information in the z axis ±direction of the pickup 75 (more accurately, the object lens 74) described later and the information record medium 7.

Numeral 73 denotes an actuator placed on the optical unit 21 and installing at least the object lens 74 described later and the pickup 75 on which the object lens 74 is placed. To form a part of a magnetic circuit, the actuator 73 is formed of metal having predetermined magnetic permeability such as iron or nickel or an alloy of the metal. Numeral 74 denotes the object lens made of a resin. The object lens 74 guides light from the light source 71 in the z axis +direction, namely, onto an L3 line, forms an image of emission light of the light source 71 on the record surface of the disc-like record medium 5 (see FIG. 2) forming a part of the information record medium 7, and further guides reflected light into the light reception sensor 72. Numeral 75 denotes the pickup. As described later in detail, the pickup 75 has an outer peripheral portion where a plurality of coils are disposed and a current is supplied to the coils, thereby acting on the magnetic circuit provided in the actuator 73, and the pickup 75 displaces in the x axis ±direction and the z axis ±direction under the control of the control section 35 (not shown in FIG. 4; see FIG. 3) based on the output of the light reception sensor 72. The control section 35 (see FIG. 3) displaces the pickup 75 in a direction of canceling the tracking error and the focus error.

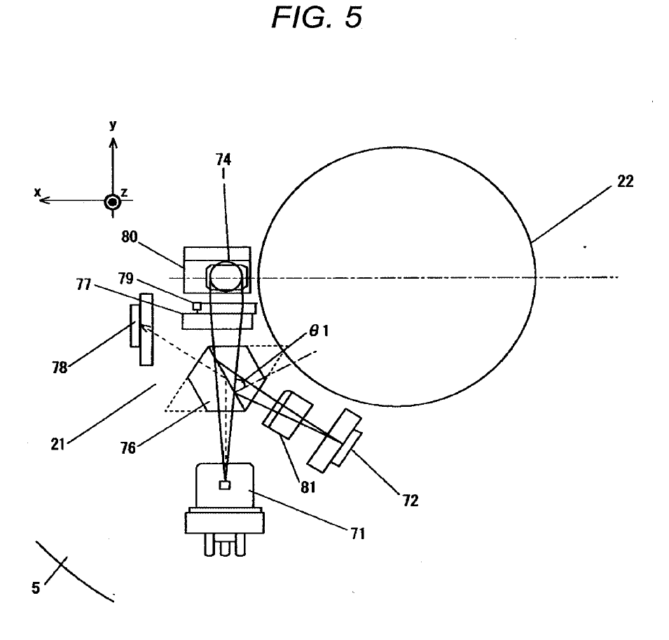

FIG. 5 is a configuration drawing to show details of the optical system of the optical unit 21 in the embodiment of the invention. In FIG. 5, the information record medium 7 housed in the information record medium housing section 8 (see FIG. 2) is placed in the z axis +direction (surface direction of the plane of the figure).

The configuration of the optical system of the optical unit 21 in the embodiment will be discussed in more detail with FIG. 5.

In FIG. 5, numeral 76 denotes a polarized beam splitter having a plurality of glass members put on each other and a polarizing film on an interface therebetween, and numeral 77 denotes a quarter λ wavelength plate for converting linear polarization into circular polarization. The quarter λ wavelength plate 77 and the polarized beam splitter 76 are used in combination, whereby go light emitted from the light source 71 and return light reflected from the information record medium 7 can be separated.

Numeral 78 denotes a light quantity monitor made up of a photodiode, etc., numeral 79 denotes a collimator lens formed of a resin for executing angle conversion of emission light of the light source 71 to parallel rays, numeral 80 denotes a mirror for bending light (parallel rays) from the light source 71 subjected to the angle conversion through the collimator lens 79 and guiding the light into the object lens 74, and numeral 81 denotes a servo lens made of a cylindrical lens for forming an image of light reflected from the information record medium 7 on the light reception sensor 72.

In the embodiment, the servo lens 81 having concave shapes on both the incidence face and the emission face is adopted because of the necessity for keeping a predetermined distance between the polarized beam splitter 76 and the light reception sensor 72. In the embodiment, the bluish purple laser is adopted as described above. However, since the bluish purple laser accelerates degradation of resin-based optical material, it is desirable that a material having bluish purple light resistance should be used for the optical components of the polarized beam splitter 76, the quarter λ wavelength plate 77, the collimator lens 79, the mirror 80, the servo lens 81, etc.

The described optical system will be discussed below in detail following the optical path:

When bluish purple laser light emitted from the light source 71 passes through the polarized beam splitter 76 and is incident on the quarter λ wavelength plate 77, it is converted from linear polarization into circular polarization. The light passing through the quarter λ wavelength plate 77 is subjected to angle conversion to parallel rays through the collimator lens 79 and then is bent about 90° in the z axis +direction through the mirror 80.

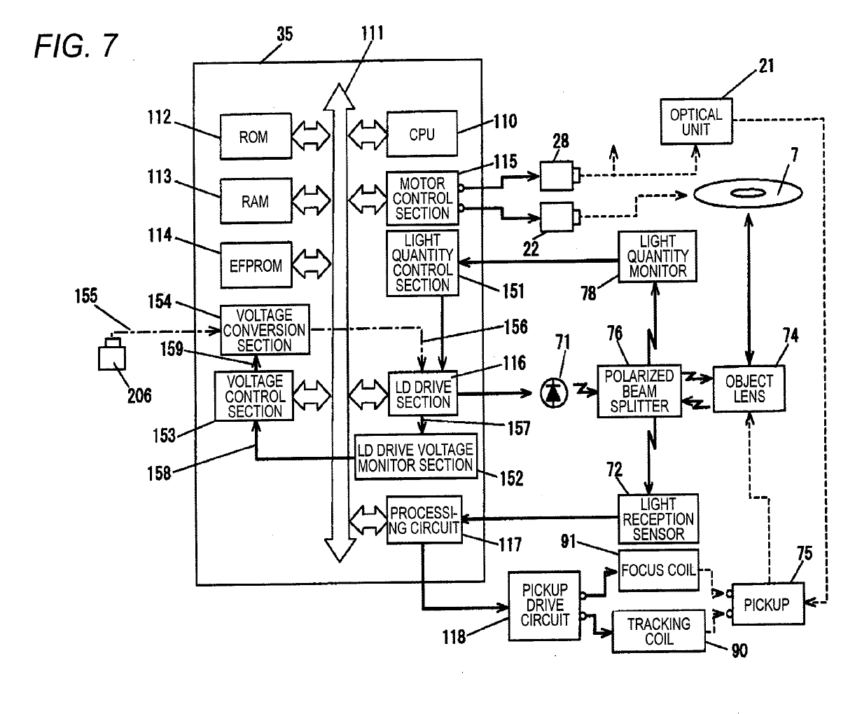

On the other hand, about 10% of the light emitted from the light source 71 is reflected on the glass member put interface of the polarized beam splitter 76 and is incident on the light quantity monitor 78. The light quantity monitor 78 outputs a light current responsive to the incidence light quantity. It is known that light output of the laser diode forming the light source 71 changes depending on the environmental temperature, etc. A light quantity control section 151 later described with reference to FIG. 7 controls the drive condition of the drive current or the drive voltage, etc., for driving the light source 71 to provide 0.5 mW as light output from the object lens 74 so that the light current value output by the light quantity monitor 78 becomes constant.

The parallel rays bent through the mirror 80 are incident on the object lens 74 and converge through the object lens 74 and consequently a light spot of 0.3 μm (full width at half maximum) is formed on the record surface of the disc-like record medium 5 at a distance of 0.22 mm from the light emission face of the object lens 74.

Since the reflection factor of the disc-like record medium 5 varies depending on the presence or absence of a pit (not shown) recorded on the disc-like record medium 5, the strength of light reflected from the information record medium 7 changes in response to the presence or absence of a pit.

The light reflected from the disc-like record medium 5 returns on the described optical path in the order of the object lens 74, the mirror 80, the collimator lens 79, and the quarter λ wavelength plate 77 and is incident on the polarized beam splitter 76. The light arriving at the interface of the polarized beam splitter 76 is reflected at a predetermined reflection factor. In the embodiment, the refection angle at this time is θ1=60° and the shape of the polarized beam splitter 76 is made a hexagon based on the angle and the thickness of the reflection film on the interface of the polarized beam splitter 76, etc., is optimized.

Generally, the refection angle on the interface of the polarized beam splitter 76 often is set to θ1=45° (namely, the polarized beam splitter 76 is a square or a rectangle). In this case, however, the placement position of the light reception sensor 72 becomes just beside in the x axis −direction relative to the polarized beam splitter 76 and thus it becomes difficult to miniaturize the optical system. In the embodiment, the outer shape of the polarized beam splitter 76 is made a hexagon and the reflection angle of the polarized beam splitter 76 is set to 60° larger than 45°, whereby the forming angle of the light reception sensor 72 and the light source 71 is provided large relative to the optical path, the light reception sensor 72 is placed slantingly, and the x axis direction width of the whole optical system is lessened.

In doing so, the optical unit 21 (see FIG. 3) can be brought closer to the spindle motor 22. This means that it is made possible for the optical unit 21 to access more the inner periphery side of the information record medium 7, and substantially the capacity of the information record medium 7 can be increased.

As described above, the reflection angle on the interface of the polarized beam splitter 76 is set larger than 45°, whereby the size of the optical unit 21 can be lessened and there is also the remarkable advantage that the inner periphery of the information record medium 7 can be more accessed in the relationship with the spindle motor 21.

The shape of the polarized beam splitter 76 need not be an equilateral hexagon and may involve deformation about a face not on the optical path; if a face on the optical path involves deformation, a minimum width not kicking light needs only to be secured. The shape of the polarized beam splitter 76 may be a parallelogram or a pentagon as indicated by the dotted lines of extensions of the sides of the polarized beam splitter 76. However, the placement side of the spindle motor 22 interferes with placement of the spindle motor 22 as shown in the figure and therefore it is desirable that the side should be cut to form a side.

The light reflected on the glass member put interface of the polarized beam splitter 76 is subjected to angle conversion so that the aspect ratio of a light spot becomes about 1:1 through the servo lens 81 made of a cylindrical lens, and is incident on the light reception sensor 72 of a four-division sensor. The incident light is converted into a light current by the light reception sensor 72 and the presence or absence of a pit formed on the disc-like record medium 5, namely, record information recorded on the information record medium 7 (see FIG. 2) can be read based on the value of the provided light current.

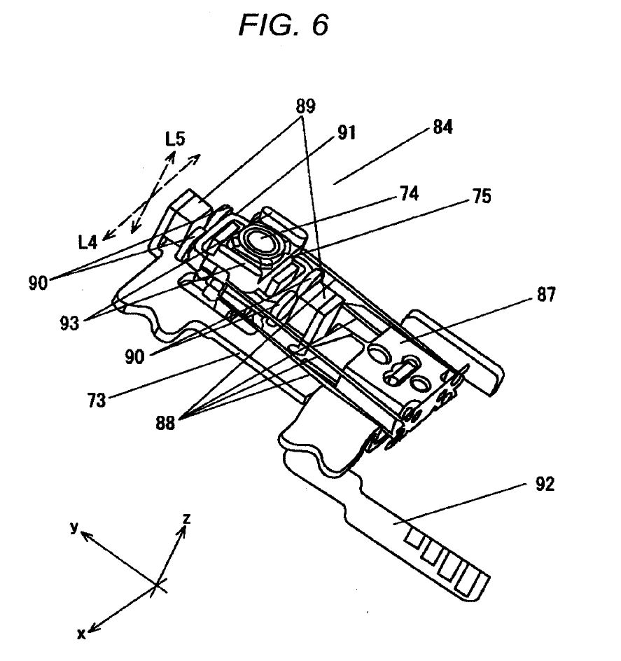

Of the optical members making up the optical unit 21, the members of the light source 71, the quarter λ wavelength plate 77, the light quantity monitor 78, the collimator lens 79, the mirror 80, the servo lens 81, and the light reception sensor 72 are placed on the carriage 70 (see FIG. 4) and the object lens 74 and the pickup 75 are placed on the actuator 73 (see FIG. 6). In the embodiment, discrete components are used and a simple configuration is adopted for the optical members.

FIG. 6 is a perspective view to show the structure of the actuator 73 in the embodiment of the invention. The structure of the actuator 73 and a configuration for displacing the position of the pickup 75 will be discussed in detail below with FIG. 6:

In FIG. 6, numeral 75 denotes the pickup simply described above. The pickup 75 supports the object lens 74 directly and has an outer peripheral portion where four tracking coils 90 and a focus coil 91 are disposed, and the tracking coils 90 and the focus coil 91 are positioned in the magnetic circuit formed by a permanent magnet placed on the actuator 73.

The pickup 75 is supported in the air by a suspension wire 88 having a length of 8 millimeters and a thickness of 50 micrometers, made of four beryllium copper wires fixed to a suspension holder 87 placed on the actuator 73. A current is supplied to the four tracking coils 90 through the suspension wire 88, whereby an object lens unit 84 displaces minutely in an L4 direction along the x axis ±direction. Likewise, a current is supplied to the focus coil 91, whereby the object lens unit 84 displaces minutely in an L5 direction along the z axis ±direction.

Numeral 92 denotes a flexible printed circuit board (FPC). The flexible printed circuit board 92 is connected to the control section 35 (see FIG. 3) and supplies a drive current to the tracking coils 90 and the focus coil 91.

Numeral 93 denotes a projection part provided in the proximity of the object lens 74 in the pickup 75 and formed of an elastic resin at least softer than the disc-like record medium 5 (see FIG. 2). The projection part 93 is formed so as to more project than the object lens 74 in the z axis +direction.

The description is continued below with FIGS. 3, 4, and 5 as well as FIG. 6:

The light reception sensor 72 of a four-division sensor previously described with reference to FIG. 5 outputs information concerning the distance between the disc-like record medium 5 and the pickup 75 and information concerning the distance from a formed light spot on the disc-like record medium 5 and a recorded pit sequence in addition to the above-described record information. The information is transmitted to the control section 35 previously described (see FIG. 3) and is converted into digital form by a processing circuit (not shown) and the information indicating the distance between the disc-like record medium 5 and the pickup 75 (see FIG. 4) and the information indicating the distance between a light spot and a pit sequence are sent to a pickup drive circuit (not shown in the figure; described later) provided in the control section 35 (see FIG. 3). The pickup drive circuit controls the relative position relationship between the disc-like record medium 5 and the pickup 75 (see FIG. 4) in real time based on the information indicating the position relationship so that stable information read can be executed.

That is, the pickup drive circuit drives the focus coil 91 based on output of the light reception sensor 72 (see FIG. 5) and accordingly displaces the pickup 75 in the z axis ±direction (L5 direction) and causes the position of the object lens 74 to follow suit in real time with respect to the already described focus error (focus servo). Further, likewise, the pickup drive circuit drives the tracking coils 90 based on output of the light reception sensor 72 (see FIG. 5) and accordingly displaces the pickup 75 in the x axis ±direction (L4 direction) and causes the position of the pickup 75 to follow suit in real time with respect to the already described tracking error (tracking servo).

The control of the pickup drive circuit is intended for always keeping constant the relative position relationship between the disc-like record medium 5 and the pickup 75. For example, if the disc-like record medium 5 is mounted inclinedly relative to the shaft (axis) of the spindle motor (see FIG. 3) for rotating and driving the disc-like record medium 5, the distance between the record surface of the disc-like record medium 5 and the pickup 75 always fluctuates in the z axis ±direction with rotation of the disc-like record medium 5 and the light spot shape formed on the record surface of the disc-like record medium 5 changes and thus it becomes difficult to perform stable read operation. The pickup 75 is caused to follow suit in real time with respect to the distance fluctuation in the z axis direction, namely, is displaced in the z axis ±direction under the control of the pickup drive circuit. Hereinafter, the range in which the pickup 75 is driven in the z axis ±direction by the pickup drive circuit will be called “normal operation range.”

The value of the current supplied to the focus coil 91 is provided with a predetermined offset, whereby the distance between the disc-like record medium 5 and the pickup 75 can be displaced stationarily. The focal position (depth direction) of the object lens 74 placed in the pickup 75 is thus aggressively controlled, whereby information recorded on each layer of the information record medium 7 having a plurality of record layers can be read.

FIG. 7 is a block diagram to show the hardware configuration of the information playback apparatus 1 in the embodiment of the invention. In FIG. 7, the solid line connecting the blocks indicating hardware components means a signal flow and the dashed line means that a mechanical connection relationship exists.

The operation of the information playback apparatus 1 will be discussed in detail below with FIG. 3 as well as FIG. 7:

In FIG. 7, numeral 110 denotes a CPU installed in the control section 35. The CPU 110 controls settings of control parameters, drive of the mechanism, etc., involved in the hardware of the information playback apparatus 1. The CPU 110 is connected to ROM 112 of nonvolatile memory storing a program, RAM 113 forming a work area of the CPU 110, and EEPROM 114 for retaining the state of the information playback apparatus 1, etc., through a bus 111. The CPU 110 is connected to a motor control section 115 through the bus 111 and rotates the spindle motor 22 in a predetermined direction through the motor control section 115 for rotating and driving the information record medium 7 (more accurately, the disc-like record medium 5 forming a part of the information record medium 7) placed in the information playback apparatus 1. Likewise, the CPU 110 rotates the feed motor 28 in forward and reverse directions through the motor control section 115 for driving the optical unit 21 (see FIG. 2) in a predetermined move range of the inner periphery and the outer periphery along the radius direction of the information record medium 7 through the carriage 70 (not shown in the figure; see FIG. 4). The actuator 73 (not shown in the figure; see FIG. 4) is installed in the optical unit 21 and the pickup 75 is installed on the actuator 73 (see FIG. 4). The CPU 110 drives the feed motor 28, thereby conveying the pickup 75 to any desired position over the inner periphery and the outer periphery of the information record medium 7.

Numeral 116 denotes an LD drive section. The LD drive section 116 causes the light source 71 made of a bluish purple laser diode to emit light. A part of the emitted light is detected by the light quantity monitor 78 and information of the light quantity is transmitted to the light quantity control section 151, which then sends a voltage control signal 159 to the LD drive section 116 so that the light quantity becomes a preset target value of the light emission quantity, whereby the light emission quantity of the light source 71 can be controlled constant. In the embodiment, a laser diode (LD) is used for the light source 71 and an infrared/red LD can be used; a blue LD having a wavelength of 405 nm is used particularly for a small-diameter optical disc.

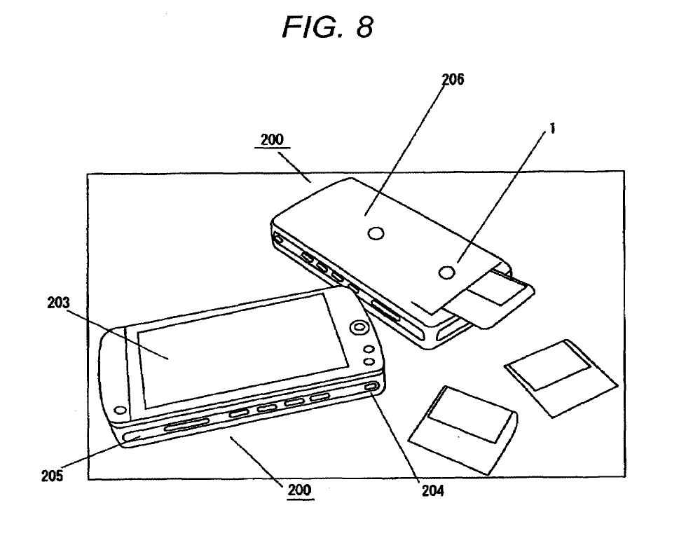

Numeral 117 denotes a processing circuit for processing reflected light from the information record medium 7. Light emitted from the light source 71 passes through the optical system previously described with reference to FIG. 5 and an image of the light is formed through the object lens 74 on the record surface of the disc-like record medium 5 forming a part of the information record medium 7 (see FIG. 8, etc.,). The reflected light is received by the light reception sensor 72. The light reception sensor 72 of a four-division sensor previously described with reference to FIG. 5 outputs information concerning the distance between the record surface of the disc-like record medium 5 and the object lens 74 and information concerning the distance from a formed light spot on the disc-like record medium 5 and a recorded pit sequence in addition to the above-described record information.

Numeral 118 denotes a pickup drive circuit. The information concerning the distances is converted into digital form by the processing circuit 117 and a signal is generated so that the value falls within the preset target value of the distance based on the information indicating the distance between the disc-like record medium 5 and the pickup 75 and the information indicating the distance between a light spot and a pit sequence. The generated control signal is converted into an analog signal and the analog signal is sent to the pickup drive circuit 118, which then drives the tracking coils 90 and the focus coil 91 in real time so that stable information read can be executed.

That is, the pickup drive circuit 118 drives the focus coil 91 based on output of the light reception sensor 72 and accordingly displaces the pickup 75 minutely in the light emission direction from the object lens 74 and its opposite direction (z axis ±direction) and causes the position of the object lens 74 to follow suit in real time with respect to the already described focus error (the operation is called focus servo). Further, likewise, the pickup drive circuit drives the tracking coils 90 based on output of the light reception sensor 72 and accordingly displaces the pickup 75 minutely in the inner periphery and outer periphery directions of the information record medium 7 (x axis ±direction) and causes the position of the pickup 75 to follow suit in real time with respect to the already described tracking error (the operation is called tracking servo).

Numeral 151 denotes the light quantity control section. About 10% of the light emitted from the light source 71 is incident on the light quantity monitor 78 as previously described with reference to FIG. 5. The light quantity monitor 78 outputs a light current responsive to the incidence light quantity. Light output of the laser diode forming the light source 71 changes depending on the environmental temperature, etc., and accordingly the light current value output by the light quantity monitor 78 also changes. To stably read the information recorded on the information record medium 7, first the light output of the light source 71 needs to be kept to a predetermined value before read is started. Thus, the LD light quantity control section 151 controls the drive condition of the drive current or the drive voltage, etc., for driving the light source 71 to provide 0.5 mW as light output from the object lens 74 so that the light current value output by the light quantity monitor 78 becomes constant.

Other components of the control section 35 are a battery 206 (described later with reference to FIG. 8 and other figures) for supplying necessary power for operating the apparatus and devices including the information playback apparatus 1, a voltage conversion section 154 for converting the voltage of the battery 206 supplied through a power supply line 155 into an optimum voltage for the operation of the LD drive section 116 and supplying the optimum voltage to the LD drive section 116 through an LD power supply (+) line 156, an LD drive voltage monitor section 152 for monitoring one characteristic of a specific component of the LD drive section 116 through a signal line 157 and standardizing a monitor signal, and a voltage control section 153 for receiving the standardized monitor signal from the LD drive voltage monitor section 152 through monitor standardization output 158 and controlling the voltage conversion section 154. These are described later in detail.

The information playback apparatus 1 described above with FIGS. 1 to 7 is installed in a portable information terminal, for example, as shown in FIG. 8.

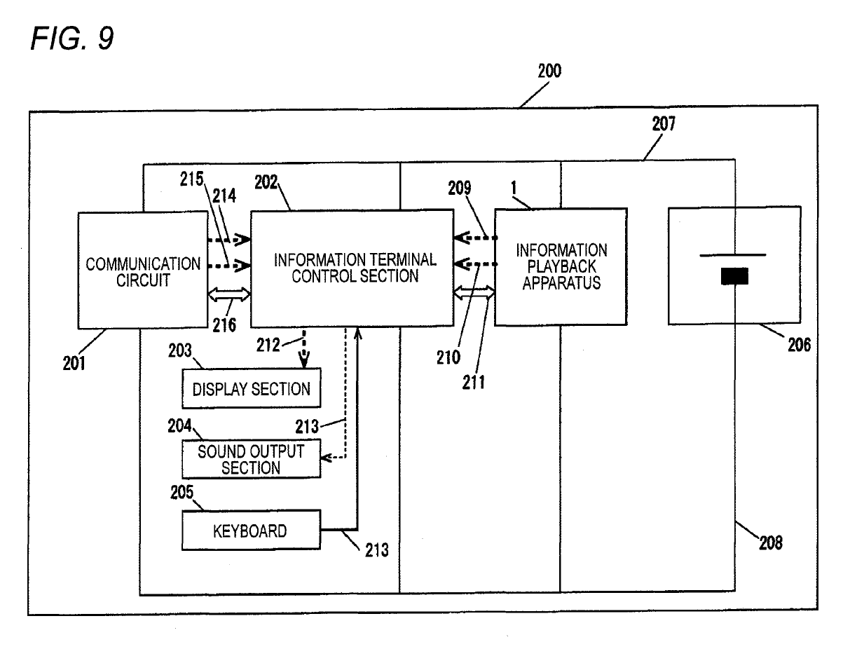

FIG. 8 is an external view to show an example of a portable information terminal in which the information playback apparatus 1 is installed in the embodiment of the invention. A portable information terminal 200 is made up of an information terminal control section 202 for operating parts other than the information playback apparatus, such as a communication circuit 201 described later with reference to FIG. 9, in addition to the information playback apparatus 1, a display section 203 for displaying moving image information played back by the information playback apparatus 1, various pieces of display information from the information terminal control section 202, etc., a sound output section 204 for outputting sound information played back by the information playback apparatus 1, various pieces of sound information from the information terminal control section 202, etc., a keyboard 205 for the user to operate the information terminal control section 202, a battery 206 for driving the information playback apparatus 1, the communication circuit 201, the information terminal control section 202, the display section 203, etc. In the embodiment, the portable information terminal shown in FIG. 8 is a mobile telephone, but may be an information terminal having a plurality of high functions, such as a smart phone or a PDA, if it is an apparatus or a device assuming that the operation only with the installed battery is the usual use mode.

FIG. 9 is an internal schematic drawing of the portable information terminal 200 in the embodiment of the invention. It schematically shows the relationships among the communication circuit 201, the information terminal control section 202, the display section 203, the sound output section 204, the keyboard 205, and the battery 206 described above and the information playback apparatus 1. The plus side of the battery 206 is connected to the sections of the communication circuit 201, the information terminal control section 202, the information playback apparatus 1, etc., through a power supply (+) line 207, and the minus side of the battery 206 is connected to the sections of the communication circuit 201, the information terminal control section 202, the information playback apparatus 1, etc., through a power supply (−) line 208. The power supply (+) line 207 and the power supply (−) line 208 supply power required for operating the sections of the portable information terminal 200, namely, the communication circuit 201, the information terminal control section 202, etc., including the information playback apparatus 1.

Numerals 209, 212, and 214 denote flows of moving image information data, numerals 210, 213, and 215 denote flows of sound information data, and numerals 211 and 216 denote control signal buses. However, the data of the same type or the control signal buses of the same type may differ in the format and the number of signal lines. For example, the moving image information data 209, 212, and 214 are the same in moving image information data, but may differ in the format and the number of signal lines. In FIG. 9, for example, for the moving image information data 209 and the sound information data 210 read out in the information playback apparatus 1, through the information terminal control section 202, the moving image information data is passed to the display section 203 according to 212 for displaying a moving image and the sound information data is passed to the sound output section 204 according to 213 for outputting a sound. Further, the moving image information data 214 and the sound information data 215 received in the communication circuit 201 may be passed to the display section 203 and the sound output section 204 respectively for displaying a moving image and outputting a sound.

The embodiment of the portion according to the invention will be discussed below in detail with the description given above as a backdrop:

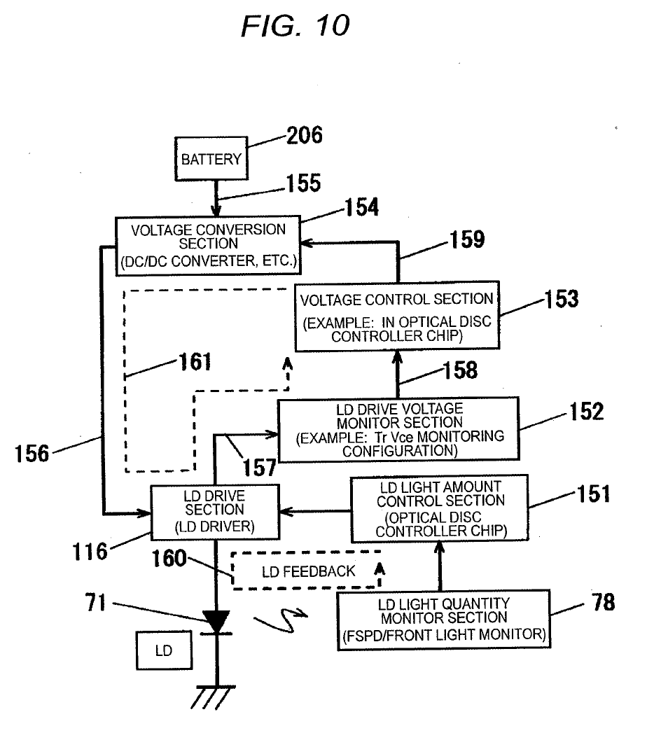

FIG. 10 is a block diagram to show the basic configuration of the embodiment of the invention. To make the description easy, the light source 71 required for reading information recorded on the information record medium 7 and the battery 206, the voltage conversion section 154 for converting the voltage of the power supply line 155 supplied from the battery 206 into an optimum voltage for the operation of the LD drive section 116 and supplying the optimum voltage to the LD drive section 116 using the LD power supply (+) line 156, the LD drive voltage monitor section 152 for monitoring and standardizing (157 in FIG. 7) one characteristic of a specific component of the LD drive section 116, the voltage control section 153 for controlling the voltage conversion section 154 so that the standardized monitor output (158 in FIG. 7) from the LD drive voltage monitor section 152 becomes a preset target value, the light quantity monitor 78 for monitoring about 10% of light emitted from the light source 71, and the LD light quantity control section 151 for controlling the drive condition of the drive current or the drive voltage, etc., for driving the light source 71 so that the light current value output by the light quantity monitor 78 becomes constant to a preset target value described in the last of the description given with reference to FIG. 7 are extracted and are also shown in the block diagram. To simplify the description, the polarized beam splitter 76 is not shown in FIG. 10.

If the light source is a blue laser diode used for a BD, etc., the operable voltage of the light source 71 of the invention is about 3.2 V to 6.8 V and is 7 V or less at the maximum. In contrast, the supply voltage of the battery 206 is 2.7 V to 4.2 V and varies according to use and charge and discharge. This means that there is a high possibility that the voltage conversion section 154 may convert the supply voltage of the battery 206 into a higher voltage than the supply voltage of the battery 206.

In the configuration described above with reference to FIG. 10, to start reading information from the disc-like record medium (optical disc) 5 shown in FIG. 2, first, supply power from the battery 206 in FIG. 10 is supplied through the power supply line 155 to the voltage conversion section 154, which then converts the applied voltage from the battery 206 into a sufficiently higher value than the operable voltage of the light source 71 (in the embodiment, 7.742 V, the maximum output voltage of the voltage conversion section 154) and supplies the voltage to the LD drive section 116 through the LD power supply (+) line 156. Then, an LD light quantity feedback loop 160 is executed. That is, as also described in FIGS. 5 and 7, about 10% of the light emitted from the light source 71 is incident on the light quantity monitor 78, which then outputs light current responsive to the incidence light quantity, and the LD light quantity control section 151 controls the LD drive section 116 so as to hold constant the light current value output from the light quantity monitor 78, and controls the drive current of the light source 71 shown in FIG. 10, etc., to provide 0.5 mW as light output from the object lens 74 shown in FIG. 7, etc.

The incidence light quantity on the light quantity monitor 78 from the light source 71 is stabilized constant according to the LD light quantity feedback loop 160 and then an LD power supply feedback loop 161 is executed. The voltage of the LD power supply (+) line 156 is lowered gradually and finally the voltage is set to the necessary minimum voltage at which the light source 71 can operate. In the embodiment, the LD drive voltage monitor section 152 monitors and shifts/standardizes the characteristic to indirectly know the power loss in the LD drive section 116 according to the signal line 157, and monitor standardization output 158 is input to the voltage control section 153. Thus, the voltage control section 153 can estimate the power loss in the LD drive section 116 according to the monitor standardization output 158 and a preset target value. The voltage control signal 159 corresponding to the estimated power loss is input to the voltage conversion section 154. The voltage conversion section 154 controls so as to lessen the power lost in the LD drive section 116, gradually updates the supply voltage to the LD power supply (+) line 156, and finally controls so that the supply voltage becomes the necessary minimum supply voltage at which the light source 71 and the LD drive section 116 can operate. Accordingly, the power loss in the LD drive section 116 can be suppressed, so that power consumption of the light source drive of the invention and various devices in which the light source drive is installed can be suppressed. Consequently, the time during which power of the battery 206 for operating the devices can be supplied can be prolonged and it is made possible to use the devices for a longer time.

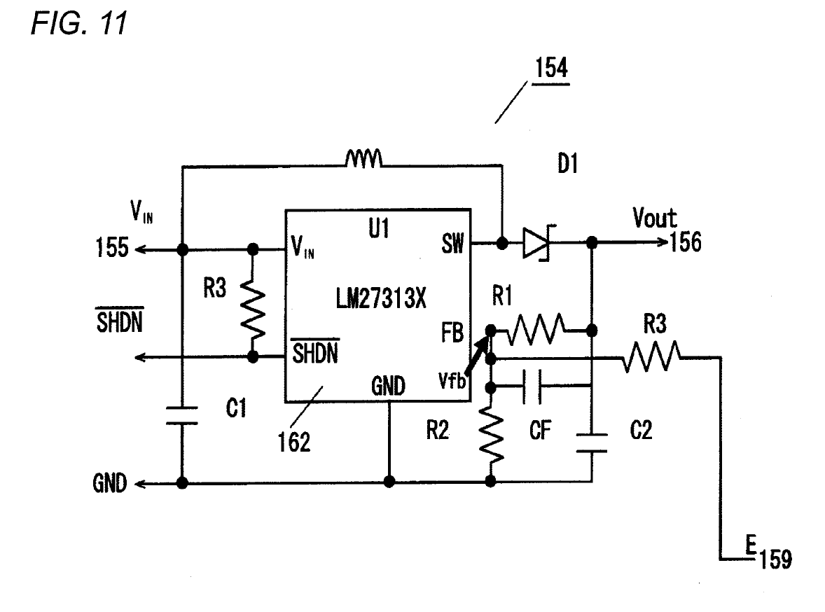

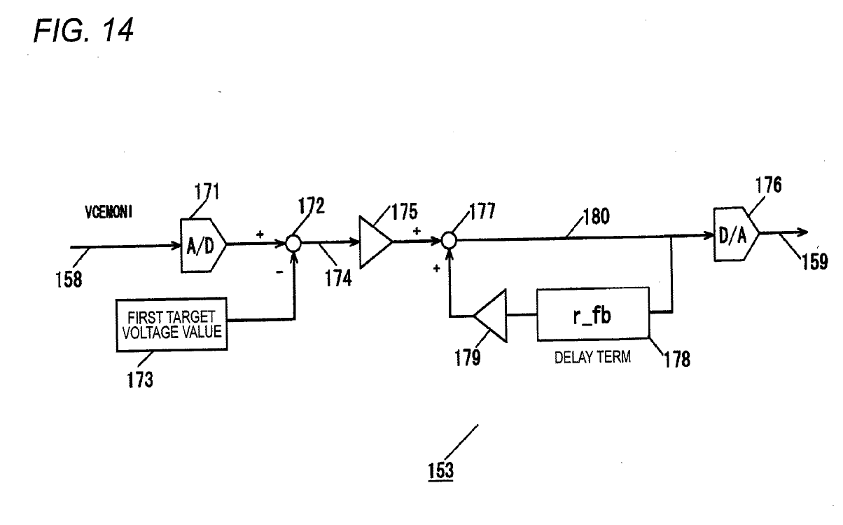

FIG. 11 is a circuit diagram to show a configuration example of the voltage conversion section 154 in the embodiment of the invention. The voltage conversion section 154 can be implemented as a DC/DC converter consisting mainly of a voltage conversion IC 162 and its peripheral circuit. In the embodiment, LM27313X is adopted for the voltage conversion IC 162. The voltage conversion IC 162 receives power supply from the battery 206 through the power supply line 155 from a VIN terminal, converts the applied voltage from the battery 206 into a voltage at which the light source 71 can sufficiently operate, and supplies power to the LD drive section 116 through the LD power supply (+) line 156. The supply voltage is determined by changing the impedance value ratio containing R1 and R2 connected to an FB terminal of the voltage conversion IC 162. The voltage control signal 159 is a signal provided by controlling so that the monitor standardization output 158 is brought close to a preset first target voltage value 173 (described later with reference to FIG. 14). The supply voltage to the LD drive section 116 and the light source 71 from the voltage conversion section 154 through the LD power supply (+) line 156 is controlled in the direction in which the power loss in the LD drive section 116 lessens and finally is lowered to the necessary minimum supply voltage at which the light source 71 and the LD drive section 116 can operate.

The output voltage of the voltage conversion section 154 by the DC/DC converter is found as follows:

Vout={(ΔR×Vfb)−(R1×R2×E)}/(R2×R3)

where ΔR=(R1×R2)+(R2×R3)+(R3×R1),

Vfb=1.23 V

Usually, as the output voltage of the DC/DC converter, a fixed value is output according to the fixed value of R1 and R2. In the embodiment, R3 is added and the impedance ratio of R1/R2/R3 is changed by the voltage control signal 159 from the voltage control section 153 (see FIGS. 7 and 10), whereby the output voltage of the DC/DC converter is made variable.

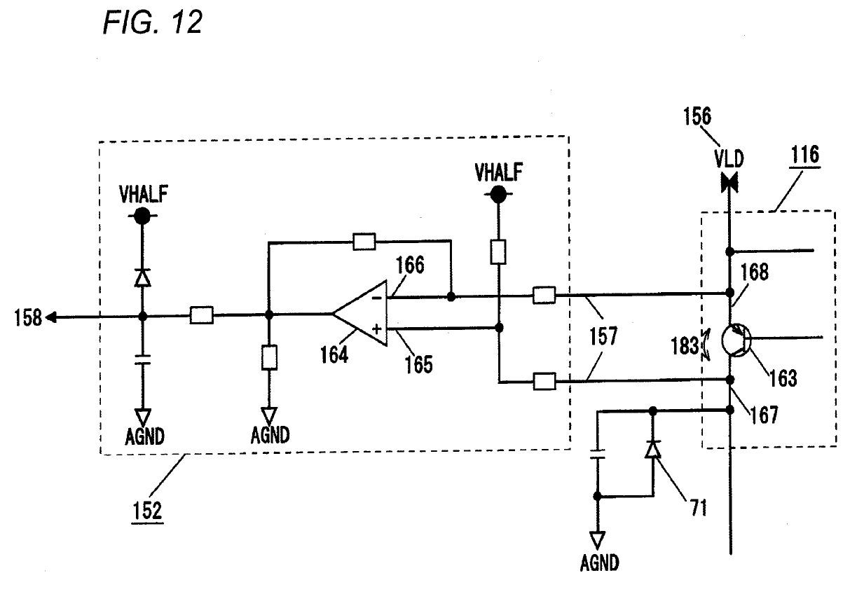

FIG. 12 is a circuit diagram to show a configuration example of the LD drive section 116 and the LD drive voltage monitor section 152 in the embodiment of the invention. A light source drive semiconductor device forming a part of the LD drive section 116 is a PNP transistor 163 (model name: 2SB1733TL) in the embodiment and the LD drive voltage monitor section 152 detects a collector-emitter voltage 183 of the PNP transistor 163. To shift/standardize the target voltage value of the collector-emitter voltage 183 to a voltage that can be input to the voltage control section 153, the LD drive voltage monitor section 152 is made up of an operational amplifier 164 and its peripheral circuit and positive input 165 and negative input 166 are connected to a collector 167 and an emitter 168 of the PNP transistor 163 respectively.

“The necessary minimum supply voltage at which the light source 71 and the LD drive section 116 (namely, the light source drive section) can operate” previously described with reference to FIG. 10 is determined considering voltage drop caused by impedance that other elements and circuits making up the LD drive section 116 have in addition to the maximum drive voltage on the specification of the light source 71 and the collector-emitter saturation voltage of the light source drive semiconductor device forming a part of the LD drive section 116, namely, the PNP transistor 163, for example.

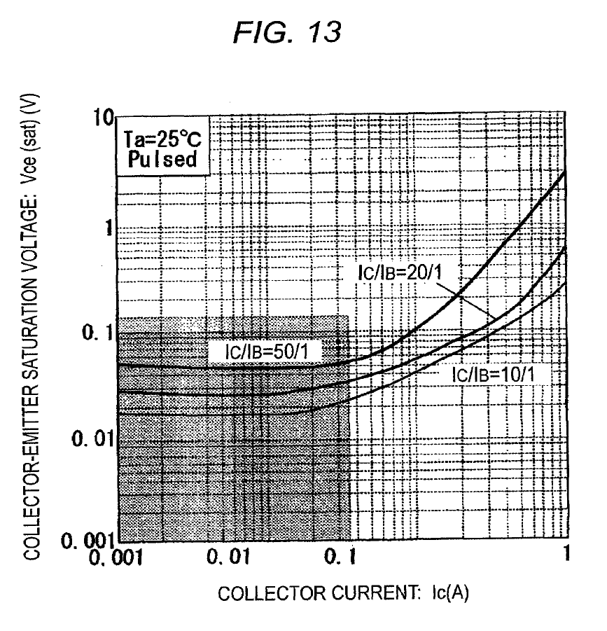

FIG. 13 is a drawing to show the relationship between the collector-emitter saturation voltage and collector current characteristic of the PNP transistor 163 of the light source drive semiconductor device forming a part of the LD drive section 116 in the embodiment of the invention. In the embodiment, the collector-emitter voltage 183 (see FIG. 12) of the PNP transistor 163 of the light source drive semiconductor device characteristic to indirectly know the power loss in the PNP transistor 163, and the collector-emitter saturation voltage is a characteristic value to indirectly suggest the fact that the power loss in the PNP transistor 163 becomes the lowest. Then, if Vce voltage of the PNP transistor 163 is controlled more than Vce saturation voltage, it is possible to operate the PNP transistor 163 in an unsaturation area. As described in detail later, it is difficult to directly measure the power loss in the PNP transistor 163 and thus the collector-emitter voltage is used as a characteristic value to indirectly know the power loss, whereby it is made possible to estimate the power loss of the PNP transistor 163 (light source drive semiconductor device) difficult to directly measure, and the power loss in the light source drive section can be suppressed.

Seeing the characteristic shown in FIG. 13 about the drive voltage range of the light source 71 used in the embodiment, namely, Ic=0.1 A or less, it is also understood that the collector-emitter saturation voltage, namely, the characteristic value to indirectly suggest the fact that the power loss in the PNP transistor 163 becomes the lowest is substantially constant (0.05 V or less even when Ic/Ib=50/1) about the same amplification factor (Ic/Ib). If the characteristic value is not substantially constant and has a large inclination to some extent or more, the necessary minimum supply voltage at which the light source 71 can operate must also be set to the upper limit of the inclination and it becomes difficult to suppress the power loss in the LD drive section 116 in the lower limit of the inclination of the characteristic value. Since the collector-emitter saturation voltage the drive voltage range of the light source 71 is substantially constant about the same amplification factor, if Vce of the PNP transistor 163 of the light source drive semiconductor device forming a part of the LD drive section 116 (the light source drive section) is controlled to a constant value of collector-emitter saturation voltage +β, the PNP transistor 163 can be operated in an unsaturation area at the necessary minimum voltage and while the power loss of the supply voltage is minimized, power supply required for driving the light source 71 can be accomplished.

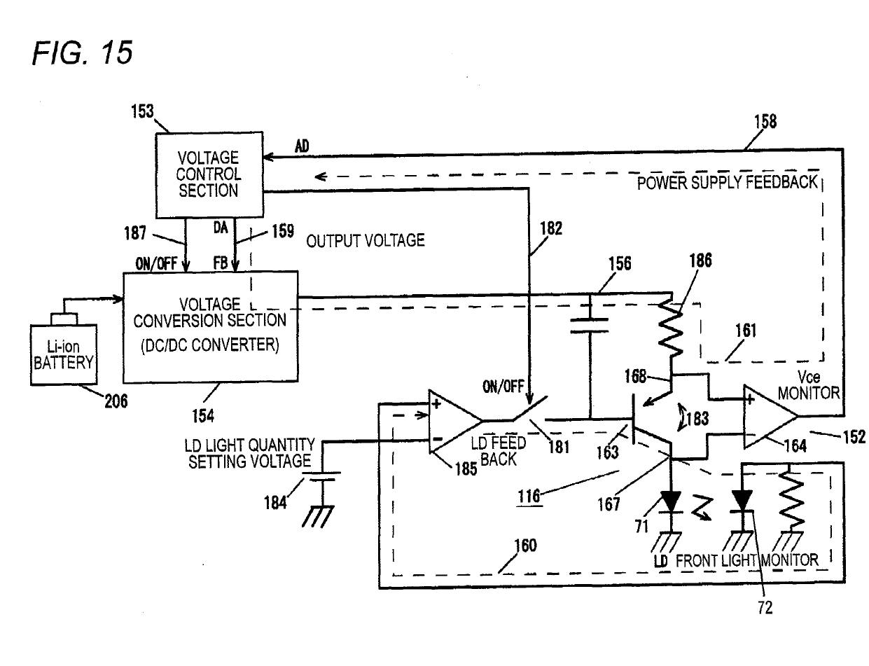

FIG. 14 is a circuit diagram to show a configuration example of the voltage control section 153 in the embodiment of the invention. The voltage control section 153 controls the voltage control signal 159 output to the voltage conversion section 154 in FIG. 15 so that the monitor standardization output 158 output by the LD drive voltage monitor section 152 approaches the first target voltage value 173 previously described with reference to FIG. 11. That is, the monitor standardization output 158 output by the LD drive voltage monitor section 152 is converted into a digital signal by an A/D converter 171 and a difference 174 from the first target voltage value 173 to bring the supply voltage to the LD drive section 116 and the light source 71 from the voltage conversion section 154 through the LD power supply (+) line 156 close to “the necessary minimum supply voltage at which the light source 71 and the LD drive section 116 can operate” is calculated by a subtracter 172 and is multiplied by a control gain 175 and addition output 180 is provided using a low-pass filter (LPF) made up of an adder 177, a delay term 178, and a delay term coefficient 179 as required. The addition output 180 is converted into an analog signal by a D/A converter 176 and the voltage control signal 159 is output to the voltage conversion section 154.

More particularly, the difference 174 between the monitor standardization output 158 and the first target voltage value 173 is multiplied by a predetermined coefficient of 0 or more and 1 or less in the control gain 175 so that the monitor standardization output approaches the first target voltage value.

The purpose of gradually bringing the monitor standardization output close to the first target voltage value 173 using a coefficient of 1 or less is to prevent overshoot, etc., from causing a defect, etc., to occur in the light source 71; considering overshoot, etc., in the embodiment, the predetermined coefficient used in the control gain 175 is 0.625.

The first target voltage value 173 is, for example, set as follows: The collector-emitter saturation voltage of the PNP transistor 163 (see FIGS. 12 and 15) of the light source drive semiconductor device forming a part of the LD drive section 116 in FIG. 7 is as shown in FIG. 13. It is seen in FIG. 13 that the maximum value of the collector-emitter saturation voltage of the PNP transistor 163 used in the embodiment is about 0.05 V The collector-emitter voltage of the PNP transistor 163 (see FIGS. 12 and 15) when the transistor is ON may be set to the collector-emitter saturation voltage shown in FIG. 13 and an unsaturation state; however, if the voltage is too large, power corresponding to the difference from the collector-emitter saturation voltage is wastefully consumed as heat. This is the power loss described so far. Therefore, if the value resulting from adding the maximum operation voltage of the light source 71 in FIG. 15 to the collector-emitter saturation voltage is applied to the LD power supply (+) line 156 of the LD drive section 116, the LD drive section 116 will operate without generating any wasteful power loss in principle.

In fact, however, the LD drive section 116 in FIG. 7 involves other elements than the PNP transistor 163 of the light source drive semiconductor device and impedance of an in-board signal line and the value needs to be determined also considering voltage drop, etc., caused by the elements. In the embodiment, a value of 0.15 V provided with a slight allowance as compared with the maximum value 0.5 V of the collector-emitter saturation voltage of the characteristic value to indirectly suggest the fact that the power loss in the PNP transistor 163 becomes the lowest is adopted as a second target voltage value, and the voltage control section 153 in FIG. 7 controls the voltage conversion section 154 so that the collector-emitter voltage of the PNP transistor 163 approaches the second target voltage value. In other words, the voltage control section 153 in FIG. 7 controls the voltage conversion section 154 so that the value resulting from adding the maximum operation voltage of the light source 71 in FIG. 15 to the second target voltage value is applied to the LD power supply (+) line 156 of the LD drive section 116.

The first target voltage value 173 in the embodiment is a standardized value in the LD drive voltage monitor section 152 so that the second target voltage value preset for the characteristic to indirectly know the power loss of the PNP transistor 163 (see FIGS. 12 and 15) of the light source drive semiconductor device forming a part of the LD drive section 116 in FIG. 7, namely, the collector-emitter voltage, namely, the value 0.15 V provided with a slight allowance as compared with the maximum value 0.5 V of the collector-emitter saturation voltage of the characteristic value to indirectly suggest the fact that the power loss of the PNP transistor 163 becomes the lowest falls within the input range of the voltage control section 153.

The first target voltage value 173 (V1) determined by such standardization (namely, setting so that the second target voltage value falls within the input range of the voltage control section 153) is found by subtracting the second target voltage value (V2) from reference voltage VHALF (=1.65 V) of the voltage control section 153 shown in FIG. 12, for example. Here, based on the fact that the maximum input-possible voltage (Vinmax) of VCEMONI is 3.3 V, the first target voltage value 173 is set in the vicinity of the center value of the input-possible voltage range and thus the first target voltage value 173 is found by subtracting the second target voltage value from the reference voltage VHALF (first example). Accordingly, it is easy to execute standardization such that the first target voltage value is set almost to the center value of the maximum input-possible voltage range of the voltage control section 153 if the second target voltage value is sufficiently small relative to the reference voltage value.

As another example, the maximum input-possible voltage of the VCEMONI terminal 158 of the voltage control section 153 in the embodiment shown in FIG. 14 is 3.3 V and thus the value resulting from subtracting the second target voltage value of the collector-emitter value of the PNP transistor 163 (see FIGS. 12 and 15) previously set from the maximum input-possible voltage 3.3 V may be adopted as the first target voltage value 173 (second example). Accordingly, if the second target voltage value is about a half of the input range of the voltage control section 153, standardization such that the first target voltage value is set almost to the center value of the input voltage range of the voltage control section 153 is possible.

To set the voltage for the standardization, in addition to the subtracting method described above (first example, second example), the following method of multiplying a predetermined voltage by α (greater than 0 and equal to or less 1.0) is also available:

{(reference voltage value of voltage control section 153)−(second target voltage value)}×α (Third example) (1)

Specifically, {(VHALF)−(V2)}×α

α is set to 1 or less (the same as the first example described above when α=1), whereby the detection voltage value of the standardized characteristic can have an allowance with respect to the upper and lower limits of the input voltage range of the voltage control section 153 as compared with the first example.

{(maximum input-possible voltage value of voltage control section 153)−(second target voltage value)}×α (Fourth example) (2)

Specifically, {(Vinmax)−(V2)}×α

α is set to 1 or less (the same as the second example described above when α=1), whereby the detection voltage value of the standardized characteristic can have an allowance with respect to the upper and lower limits of the input voltage range of the voltage control section 153 as compared with the second example.

{(second target voltage value)÷(maximum voltage value of second target voltage value)×(maximum input-possible voltage value of voltage control section 153)}×α (Fifth example) (3)

Specifically, {(V2)÷(V2max)×(Vinmax)}×α

In this example, if the second target voltage value V2 exceeds the maximum input-possible voltage value Vinmax of the voltage control section 153, the first target voltage value V1 can also be set in the maximum input-possible voltage value Vinmax of the voltage control section 153 and it is made possible to control voltage. α is set, whereby the detection voltage value of the standardized characteristic can have an allowance with respect to the upper and lower limits of the maximum input-possible voltage range of the voltage control section 153.

{(reference voltage value of voltage control section 153)−(detection voltage value of characteristic)×α (Sixth example) (4)

Specifically, {(VHALF)×(Vce)}×α

In this example, if the second target voltage value V2 is sufficiently smaller than the reference voltage value VHALF of the voltage control section 153 and is standardized by the third example method to provide the first target voltage value and the detection voltage value Vce of the characteristic is brought close to the second target voltage value V2, the corresponding detection voltage value is also standardized in accordance with the sixth example, whereby the detection voltage value of the standardized characteristic can be made to fall within the first target voltage value set almost to the center value of the input-possible voltage range of the voltage control section 153. α is set, whereby the detection voltage value of the standardized characteristic can have an allowance with respect to the upper and lower limits of the maximum input-possible voltage range of the voltage control section 153.

{(maximum input-possible voltage value of voltage control section 153)−(detection voltage value of characteristic)}×α (Seventh example) (5)

Specifically, {(Vinmax)−(Vce)}×α

In this example, if the second target voltage value V2 is about a half of the maximum input-possible voltage value of the voltage control section 153 and is standardized by the fourth example method to provide the first target voltage value and the detection voltage value Vce of the characteristic is brought close to the second target voltage value V2, the detection voltage value of the standardized characteristic can be made to fall within the first target voltage value set almost to the center value of the input-possible voltage range of the voltage control section 153. α is set, whereby the detection voltage value of the standardized characteristic can have an allowance with respect to the upper and lower limits of the maximum input-possible voltage range of the voltage control section 153.

{(detection voltage value of characteristic)÷(maximum value of detection voltage of characteristic)×(maximum input voltage value of voltage control section 153)}×α (Eighth example) (6)

Specifically, {(Vce)÷(Vcemax)×(Vinmax)}×α

In this example, if the second target voltage value exceeds the maximum input-possible voltage value of the voltage control section 153 and is standardized by the fifth example method, the detection voltage value of the characteristic is also standardized like the second target voltage value according to the eighth example to provide the first target voltage value. According to the method, if the second target voltage value exceeds the input-possible voltage range of the voltage control section 153, standardization is performed, whereby voltage control is possible. α is set, whereby the detection voltage value of the standardized characteristic can have an allowance with respect to the upper and lower limits of the maximum input-possible voltage range of the voltage control section 153.

In any way, the second target voltage value is thus set so as to fall within the input range of the voltage control section 153, whereby standardization of the voltage control section 153 can be easily accomplished.

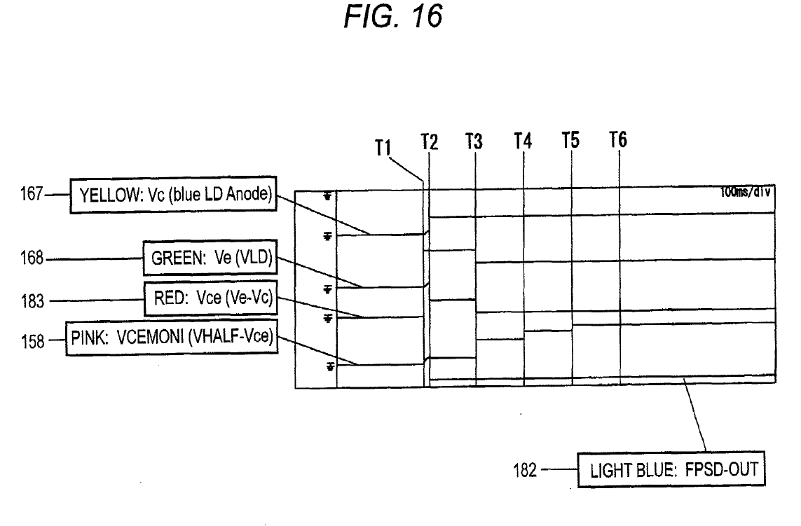

The operation of the sections in the embodiment of the invention described above will be discussed more easily in time sequence with FIGS. 15 and 16. FIG. 15 is a drawing to describe the configuration shown in FIG. 10 in more detail, and FIG. 16 is a drawing of an oscilloscope to show time change of voltages occurring in the sections in FIG. 15. Each voltage in FIG. 16 is voltage relative to a ground and the reference numeral shown at the left of each change graph indicates voltage change of the part indicated by the same reference numeral in FIG. 15. Specifically, voltage change of the anode of the light source 71 and the collector 167 of the PNP transistor 163 in FIG. 15 is Vc in FIG. 16; voltage change of the emitter 168 of the PNP transistor 163 in FIG. 15 is Ve in FIG. 16; change of the voltage 183 between the collector 167 and the emitter 168 of the PNP transistor 163 in FIG. 15 is Vce in FIG. 16; voltage change of output 158 from the operational amplifier 164 in FIGS. 12 and 15 is VCEMONI in FIG. 16; and change of voltage into which the current value of a front light monitor 72 for monitoring the light quantity of the LD 71 in FIG. 15 is converted is FPSD-OUT in FIG. 16. An operational amplifier 185 and an LD light quantity setting voltage 184 in FIG. 15 correspond to the LD light quantity control section 151 in FIG. 7. The operational amplifier 164 in FIG. 15 is shown by simplifying the configuration of the LD drive voltage monitor section 152 shown in FIG. 12 and actually performs standardization processing. VCEMONI in FIG. 16 is voltage change of the voltage control signal 159 of the voltage conversion section 154 output by the voltage control section 153 so that the voltage of the monitor standardization output 158 output by the LD drive voltage monitor section 152 in FIG. 15 approaches the preset first target voltage value 173 in FIG. 14.

First, at time T1 in FIG. 16, supply power from the battery 206 in FIGS. 10 and 16 is supplied through the power supply line 155 to the voltage conversion section 154, which then converts the applied voltage from the battery 206 into a sufficiently higher value than the operable voltage of the light source 71 (in the embodiment, 7.742 V) and supplies the voltage to the LD drive section 116 through the LD power supply (+) line 156. Then, an LD light quantity feedback loop 160 is executed. At this time, although not shown in FIG. 16, an ON/OFF control signal 187 of the voltage conversion IC 162 is set to ON for the voltage conversion section 154 from the voltage control section 153 in FIG. 15. The voltage of the voltage control signal 159 to the FB terminal is set so that the LD power supply (+) line 156 becomes a voltage preset sufficiently higher than the maximum operable voltage of the light source 71 (in the embodiment 7.742 V). Since FPSD-OUT 182 in FIG. 16 is almost 0 V, the PNP transistor 163 in FIG. 15 is OFF (namely, the LD 72 is turned off). Although a slight voltage occurs, Vc 167 does not reach the drive voltage and thus the LD is not lit. Therefore, Vce in FIG. 16 is a value resulting from subtracting the voltage of the collector 167 of the light source 71, namely, Vc in FIG. 16 from the voltage of the LD power supply (+) line 156 in FIG. 15 (in the embodiment 7.742 V) and the operational amplifier 164 is used with a single power supply as shown in FIG. 12 and thus VCEMONI which became a minus value in FIG. 16 outputs 0 V.

Next, at time T2 shown in FIG. 16, a switch 181 is set to ON to drive the light source drive semiconductor device forming a part of the LD drive section 116 in FIGS. 10 and 15, namely, the PNP transistor 163 and the LD light quantity feedback loop 160 previously described with reference to FIG. 10 is executed. After the incidence light quantity on the light quantity monitor 78 from the light source 71 is stabilized, namely, the FPSD-OUT 182 becomes a constant value, the LD power supply feedback loop 161 previously described with reference to FIG. 10 is executed.

The voltage Vc in FIG. 16 is the operation voltage of the light source 71 in FIG. 15 and varies depending on individual difference, variation with time, ambient temperature, etc. However, it may be assumed that Vc is almost constant in a short time of about times T2 to T6 (T2-T3/T3-T4/T4-T5/T5-T6; all 10 ms) in FIG. 16.

In the time period T2 to T6, the emission light quantity of the light source 71 in FIG. 15 is kept constant as indicated in the FPSD-OUT 182. Thus, the LD power supply (+) line 156 is set to a preset sufficiently high initial voltage (in the embodiment 7.742 V) and the emission light quantity of the light source 71 is stabilized and then control of power supply voltage from the voltage conversion section 154 to the LD drive section 116 (namely, the light source drive section) is executed, whereby the power loss in the LD drive section 116 (namely, the light source drive section) at the reading time from the optical disc 7 can be suppressed.

The reason why supply of the initial voltage from the voltage conversion section 154 to the LD drive section 116 (namely, the light source drive section) is started before the light quantity from the light source 71 is emitted according to the LD light quantity feedback loop 160 is as follows: If supply of voltage is not started before light is lit from the light source 71, the light source 71 cannot be lit and when supply of the initial voltage is started, a large beard (spike) is put on the output voltage from the voltage conversion section 154 and it is feared that an excessive current may flow into the light source 71, producing adverse effects of excessive light emission, etc., in some cases.

Further, at time T3 shown in FIG. 16, the voltage control section 153 in FIG. 15 inputting VCEMONI at the time T2 calculates the difference 174 between VCEMONI and the preset first target voltage value 173 in FIG. 14, and changes the voltage control signal 159 of the voltage conversion section 154 in the direction in which the voltage of the monitor standardization output 158 output by the LD drive voltage monitor section 152 in FIG. 15 approaches the first target voltage value 173 in FIG. 14. Consequently, the output voltage of the LD power supply (+) line 156 from the voltage conversion section 154 lowers. As described above, the operation voltage of the light source 71 and the voltage drop in a resistor 186 are almost constant and thus the voltage 183 between the collector 167 and the emitter 168 of the PNP transistor 163, namely, Vce in FIG. 16 lowers in proportion to lowering of the output voltage of the LD power supply (+) line 156 in FIG. 15. As Vce in FIG. 16 lowers, it more approaches the second target voltage value and thus VCEMONI becomes higher than that at the time T2 and more approaches the first target voltage value 173 in FIG. 14.

As at the time T3 in FIG. 16, the voltage of the LD power supply (+) line 156 in FIGS. 10 and 15 is gradually lowered from time T4 to time T6 and Vce in FIG. 16 more approaches the second target voltage value. Thus, VCEMONI at the time in FIG. 16 becomes higher than that at the preceding time and becomes a value closer to the first target voltage value 173 in FIG. 14 and finally the difference between VCEMONI and the first target voltage value 173 falls within a given range. Consequently, the voltage of the LD power supply (+) line 156 in FIGS. 10 and 15 is set to the necessary minimum voltage at which the light source 71 in FIG. 15 can operate. In the embodiment, the voltage of the LD power supply (+) line 156 can be lowered from 7.12 V at the time T1 in FIG. 16 to 4.42 V finally at time T6.

Thus, after the emission light quantity of the light source 71 is stabilized, the power supply voltage from the voltage conversion section 154 to the LD drive section 116 (namely, the light source drive section) is set, whereby the power loss in the LD drive section 116 (namely, the light source drive section) can be suppressed under the same condition as at the reading time from the optical disc 7.

The drive voltage supply from the voltage conversion section 154 to the LD drive section 116 is terminated after the LD drive section 116 turns off the light source 71 under the control of the LD light quantity control section 151. The drive voltage supply can be terminated according to the following procedures: One is a procedure of turning off the power source by usually stopping playback of the disc 2 and the other is a procedure of turning off the power source by detecting that the top cover 3, the top chassis 9, and the information record medium housing section 8 move in the direction D2 and are opened in FIG. 2 in the embodiment, for example. Whether or not they are opened can be detected by the fact that a bend part P1 provided on a side of the top cover 3 is brought close to or away from the lower portion using a housing section open/closing detection sensor 14, for example. The mechanism for detecting the housing section being opened or closed is collectively called “door switch.” In the former procedure, preferably the LD power supply feedback loop 161 is turned off and then the voltage conversion section 154 is terminated. In the latter procedure, if the voltage supply from the voltage conversion section 154 is turned off with the LD power supply feedback loop 161 remaining on, it is made possible to turn off the light source 71. However, to close the door switch and again turn on the light source 71, supply of the initial voltage from the voltage conversion section 154 to the LD drive section 116 (light source drive section) needs to be started before the light quantity from the light source 71 is emitted after the LD light quantity feedback loop 160 is once turned off.

The following two are possible as the voltage at the supply start time of the voltage conversion section 154 described above: One is the maximum output voltage of the voltage conversion section 154 and the other is voltage +β at the turning off time when the light source was previously turned on. The maximum output voltage can be determined considering Vop maximum voltage of the LD of the light source 71 (considering variations, variation with time, temperature change) and the impedance of the components and the lines. To implement the voltage control section 153 as a microcomputer, the output voltage at the previous turning off time at the previous turning on time is stored and can be used at the next turning on time. The voltage value when the light source is again turned on is adopted as stored value +β. It is considered that β is 0 or more and the difference from the maximum voltage or less.

Voltage update from the voltage conversion section 154 to the LD drive section 116 by the voltage control section 153 is started after current control of the LD drive section 116 by the LD light quantity control section 151 is started and the light quantity emitted from the light source 71 is stabilized. That is, after the LD power supply feedback loop 161 is turned on and the Vce voltage of the PNP transistor 163 of the LD drive section 116 is determined, voltage update is started, because a possibility of voltage shortage in lighting (turning on) the LD (light source 71) occurs if voltage conversion update when Vce is undetermined is executed.

Voltage update from the voltage conversion section 154 to the LD drive section 116 by the voltage control section 153 is terminated after current control of the LD drive section 116 by the LD light quantity control section 151 is terminated and the light quantity emitted from the light source 71 disappears for preventing a defect of current control of turning on the LD and damage to the peripheral circuit containing the LD in a state in which the control circuit is powered off and there is a possibility that current supply to the LD may become insufficient.

The update rate of the supply voltage from the voltage conversion section 154 to the LD drive section 116 by the voltage control section 153 is set equal to or more than the update rate of the current control of the LD drive section 116 by the LD light quantity control section 151. That is, the voltage update rate of the voltage conversion section 154 needs to be a higher rate than the current control by the LD light quantity feedback loop 160. If the update timing of the voltage conversion section 154 is behind the update timing of the current control by the LD light quantity feedback loop 160, the PNP transistor 163 forming a part of the LD drive section 116 becomes a saturation area from an unsaturation area, a lag occurs in the necessary power supply for driving the LD, and there is a possibility that the LD cannot be lit in any desired light emission quantity. In this connection, in the embodiment, the update rate in the voltage control section 153 is 100 ms under microcomputer control and an about 1-Hz servo band in actual measurement is secured. On the other hand, the update rate of the current control by the LD light quantity feedback loop 160 is several 10 s to several min, current change of the LD is very late, and the update quantity is also small.

The update rate of the supply voltage from the voltage conversion section 154 to the LD drive section 116 by the voltage control section 153 can be made variable in response to the update quantity of the supply voltage. That is, when the update quantity of the supply voltage is large (when change is large), the update rate is increased and when the update quantity is small, the update rate is decreased, whereby the update rate can be made instantly to respond to the voltage change.

The voltage control section 153 not only can be implemented as a discrete circuit shown in FIG. 14, but also can be provided by AD/DA conversion and computation of a microcomputer. That is, the standardized monitor standardization output 158 from the operational amplifier 164 for Vce monitor is converted into an analog form and control computation in the microcomputer is performed, namely, the difference between a preset target value and a monitor value is multiplied by a gain. Processing of clipping in the upper limit and the lower limit, etc., is performed so that the computation result obtained at the time does not overflow from the upper limit or the lower limit, and computation processing is performed. If the processing is not performed, the voltage control signal 159 moves up and down and consequently the voltage output from the voltage conversion section 154 also moves up and down together. The computation output (digital value) is converted into an analog value and the voltage control signal 159 as analog output is output. The output voltage of the voltage conversion section 154 is controlled by the voltage control signal 159. Processing of the microcomputer is thus performed, whereby the target value, the gain, and the update time can be changed programmably and an LD configuration circuit can be flexibly dealt with. For example, it is made possible to store and reuse the voltage control signal 159 when the light source 71 is previously turned on and then off. Further, the number of components can be decreased as compared with the number of components of the discrete circuit as in FIG. 14 and the mounting area can be reduced as compared with that of the discrete circuit.

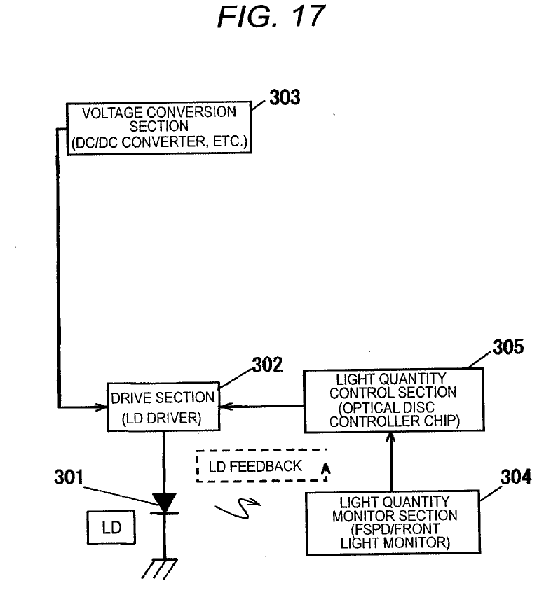

Last, in the information playback apparatus 1 using a lithium ion battery having a capacity of 1800 mAh as the battery 206 shown in FIG. 7, the use time was measured in the case where control of the voltage conversion section 154 in FIG. 15 according to the invention is performed and the state at the time T6 in FIG. 16 is entered and then consecutive read operation of the disc 7 is performed and the case where the control according to the invention is not performed and consecutive read operation is performed as in the state at the time T2 in FIG. 16. In this connection, it may be considered that the latter is equivalent to FIG. 17 taken up as the related art example in the Specification. Consequently, in the embodiment, consecutive operation of about four hours 10 minutes was performed in the former case and consecutive operation of about three hours 30 minutes was performed in the latter case and it turned out that the former can be used longer about 40 minutes than the latter.

The reason is as follows: The difference between the voltage between the collector 167 and the emitter 168 of the PNP transistor 163 in FIG. 15, namely, Vce in FIG. 16 and the collector-emitter saturation voltage shown in FIG. 13 in the latter is larger than that in the former and power corresponding to the difference is wastefully consumed as heat, as described above.

The operation voltage of the light source 71 in the embodiment typically is 4.4 V. However, if the voltage is 6.67 V, the maximum operation voltage, control can be performed up to a voltage lower than the voltage 7.12 V of the LD power supply (+) line 156 in the case where control of the voltage conversion section 154 in FIG. 15 according to the invention is not performed. Thus, the system can also be used for a longer time than that in the case where control of the voltage conversion section 154 in FIG. 15 according to the invention is not performed.

The purpose of applying an initial voltage once as conventional and gradually lowering the voltage to a predetermined voltage as in the embodiment is to once cause the light source 71 to emit light and detect the necessary voltage at the point in time since the voltage required for the light source 71 changes depending on ambient temperature and variation with time and to minimize the voltage of the light source 71 required at the apparatus using time.

Thus, if the initial voltage is lowered to lower power consumption according to the conventional method, it is feared that the light source 71 cannot be used depending on the state of the light source 71 and conventionally the voltage is set to a voltage at which the light source 71 is driven in any state.

As described above, according to invention, power consumption of the light source drive can be suppressed, the time during which power of the battery for operating the light source drive and various devices in which the light source drive is installed can be supplied can be prolonged, and it is made possible to use the devices for a longer time.

In the embodiment, the main light source drive semiconductor device forming a part of the LD drive section 116 is the PNP transistor 163, but the main light source drive semiconductor device forming a part of the LD drive section of the invention is not limited to the PNP transistor 163. It may be an NPN transistor or an FET if it can be configured so as to suppress the power loss in the LD drive section 116, suppress power consumption of the light source drive of the invention, prolong the time during which power of the battery for operating the light source drive and various devices in which the light source drive is installed can be supplied, and make it possible to use the devices for a longer time. In this case, for the drive device used for the LD drive section 116, it is desirable that the characteristic (Vce) to indirectly know the degree of the power loss in the LD drive section 116 should become substantially constant in the current range in which the light source 71 can be driven. Accordingly, the necessary minimum supply voltage at which the light source 71 can operate can be suppressed as much as possible, so that power consumption of the light source drive of the invention and various devices in which the light source drive is installed can be supplied, the time during which power of the battery for operating the apparatus and the device can be supplied can be prolonged, and it is made possible to use the apparatus and the devices for a longer time.

As described above, a first aspect of the invention provides a light source drive having a light source; a light source drive section for driving the light source; and a voltage conversion section for converting a supply voltage from a battery for supplying power into a supply voltage to the light source drive section, wherein the voltage conversion section sets the supply voltage from the battery to the light source drive section to a preset initial voltage and then lowers the voltage to a predetermined voltage lower than the initial voltage, at which the light source drive section and the light source are driven.

Accordingly, power consumption of the light source drive can be suppressed and the time during which power of the battery for operating the light source drive and various devices in which the light source drive is installed can be supplied can be prolonged, so that it is made possible to use the devices for a longer time.

A second aspect of the invention is as follows: In the first aspect of the invention, the initial voltage is set and after the light amount of the light source is stabilized, the voltage is lowered to the predetermined voltage.

Accordingly, after the emission light quantity of the light source is stabilized at the preset sufficiently high initial voltage, power supply voltage from the voltage conversion section the light source drive section is set, whereby the power loss in the light source drive section can be suppressed in a state in which the light quantity required for reading from an optical disc is emitted.

A third aspect of the invention is as follows: In the first aspect of the invention, the light source drive section contains a light source drive semiconductor device for driving the light source and the predetermined voltage is the sum of the voltage of the light source after set to the initial voltage and the voltage at which the light source drive semiconductor device is driven in an unsaturation area.

Accordingly, while the power loss is decreased, the light source drive section can be driven reliably.

A fourth aspect of the invention is as follows: In the first aspect of the invention, the voltage conversion section gradually lowers the voltage from the initial value to the predetermined voltage.

Accordingly, the effect of overshoot, etc., occurring when the voltage is lowered is not received and the stable operation can be realized.

A fifth aspect of the invention is as follows: The light source drive in the first aspect of the invention further has a light quantity detection section for detecting the light quantity of light emitted from the light source; and a light quantity control section for controlling the light source drive section so that the light quantity matches a target value based on the detection result of the light quantity detection section, wherein the light quantity control section stabilizes the light quantity of the light source.

Accordingly, the power loss in the light source drive section can be suppressed in a state in which the light quantity required for reading from an optical disc is emitted.

A sixth aspect of the invention is as follows: In the first aspect of the invention, the light source drive section contains a light source drive semiconductor device for driving the light source and the light source drive semiconductor device has a characteristic to indirectly know a power loss.

The expression “characteristic to indirectly know a power loss” is an electric unit according to which the power loss of the light source drive semiconductor device can be estimated. If the emission light quantity from the light source is almost constant according to light source drive by the light source drive semiconductor device, the “characteristic to indirectly know a power loss” refers to the voltage across the light source drive semiconductor device at the time. One of the power loss “current X voltage” is detected without directly measuring the power loss of the light source drive semiconductor device and is controlled to a low value and consequently the power loss of the light source drive semiconductor device is suppressed. Thus, using the “characteristic to indirectly know a power loss,” it is made possible to estimate the power loss of the light source drive semiconductor device difficult to directly measure and the power loss in the light source drive section can be suppressed.

A seventh aspect of the invention is as follows: In the sixth aspect of the invention, the voltage of the light source drive section drives in the range in which the upper limit is a value resulting from adding the difference value between the maximum drive voltage and the minimum drive voltage of the light source and a characteristic value to indirectly suggest the fact that the light source can be driven and the power loss of the light source drive semiconductor device becomes the lowest in a range in which the light source can be driven and the lower limit is a value at which the power loss of the light source drive semiconductor device becomes the lowest.

The expression “characteristic value to indirectly suggest the fact that the power loss becomes the lowest” is an electric unit according to which it can be estimated that the power loss of the light source drive semiconductor device becomes the lowest, and refers to the voltage across the light source drive semiconductor device where the “characteristic to indirectly know a power loss” becomes the minimum. Like the power loss of the light source drive semiconductor device, the characteristic value is used without directly measuring the lowest value of the power loss. The characteristic value can be previously known according to the specification value (catalog value) indicating the characteristic of the light source drive semiconductor device and can be used at the design time. The target value is set in the given range in which the lower limit is the characteristic value and the upper limit is a value resulting from adding the difference value between the maximum drive voltage and the minimum drive voltage of the light source to the characteristic value, and the above-mentioned “characteristic to indirectly know a power loss” is limited with respect to the target value, whereby the power loss in the light source drive section also containing other components than the light source drive semiconductor device is optimized and accordingly the power loss in the light source drive section can be suppressed in the range in which the light source can be driven.

An eighth aspect of the invention is as follows: In the seventh aspect of the invention, the characteristic value to indirectly suggest the fact that the power loss of the light source drive semiconductor device becomes the lowest is substantially constant in a current range in which the light source can be driven.

Accordingly, the voltage at which the power loss of the light source drive semiconductor device forming a part of the light source drive section becomes the lowest is suppressed to a substantially constant low value in the whole range of the drive current of the light source, so that the power loss of the light source drive semiconductor device can be minimized if the drive voltage of the light source changes.

A ninth aspect of the invention is as follows: In the seventh aspect of the invention, the light source drive semiconductor device is a transistor, the characteristic to indirectly know the power loss of the light source drive semiconductor device is a collector-emitter voltage of the transistor, and the characteristic value to indirectly suggest the fact that the power loss of the light source drive semiconductor device becomes the lowest is the saturation voltage between the collector and the emitter of the transistor.

Accordingly, it is made possible to estimate the power loss of the light source drive semiconductor device difficult to directly measure and the power loss in the light source drive section can be suppressed.

A tenth aspect of the invention is as follows: The light source drive in the sixth aspect of the invention further has a monitor section for detecting the characteristic to indirectly know the power loss of the light source drive semiconductor device and standardizing so that the detected characteristic falls within a value in the input range of the voltage conversion section; and a voltage control section for controlling a power supply voltage from the voltage conversion section to the light source drive section so that the voltage detected by the monitor section becomes a preset first target voltage value, wherein the first target voltage value is a standardized value so that a second target voltage value preset for the characteristic to indirectly know the power loss falls within the input range of the voltage control section and the second target voltage value is set equal to or more than the characteristic value to indirectly suggest the fact that the power loss of the light source drive semiconductor device becomes the lowest in the current range in which the light source can be driven and equal to or less than a voltage value resulting from adding the difference value between the maximum drive voltage and the minimum drive voltage of the light source and a characteristic value to indirectly suggest the fact that the light source can be driven and the power loss of the light source drive semiconductor device becomes the lowest in the current range in which the light source can be driven.

Accordingly, it is made possible to estimate the power loss of the light source drive semiconductor device difficult to directly measure and the power loss in the light source drive section can be suppressed without breaking the circuit.

An eleventh aspect of the invention is as follows: In the tenth aspect of the invention, the first target voltage value is a preset value in computation of {(reference voltage value of the voltage control section)×(the second target voltage value)}×α (where α is a numeric value larger than 0 and equal to or less than 1).

Accordingly, it is easy to accomplish such standardization of setting the first target voltage value to almost the center value of the maximum input-possible voltage range of the voltage control section if the second target control value is sufficiently small relative to the value of the reference voltage. α is set to 1 or less, whereby an allowance of the upper and lower limits of standardized monitor value input can be provided for the input voltage range of the voltage control section.

A twelfth aspect of the invention is as follows: In the tenth aspect of the invention, the first target voltage value is a preset value in computation of {(maximum input-possible voltage value of the voltage control section)−(the second target voltage value)}×α (where α a is a numeric value larger than 0 and equal to or less than 1).

Accordingly, it is possible to execute such standardization of setting the first voltage target value to almost the center value of the input voltage range of the voltage control section if the second target voltage value is about a half of the input range of the voltage control section. α is set to 1 or less, whereby an allowance of the upper and lower limits of standardized monitor value input can be provided for the input voltage range of the voltage control section.

A thirteenth aspect of the invention is as follows: In the tenth aspect of the invention, the first target voltage value is a preset value in computation of {(the second target voltage value)÷(maximum voltage value of the second target voltage value)×(maximum input-possible voltage value of the voltage control section)}×α (where α is a numeric value larger than 0 and equal to or less than 1).

In the invention, the first target voltage value is a value standardized by dividing the second target voltage value to be set by the maximum voltage value of the second target voltage value and multiplying the result value by the maximum input-possible voltage value of the voltage control section. If the second target voltage value exceeds the maximum input-possible voltage value of the voltage control section, the first target voltage value can be set in the maximum input-possible voltage range of the voltage control section and it is made possible to control the voltage. α is set, whereby an allowance of the upper and lower limits of standardized monitor value input can be provided for the maximum input-possible voltage of the voltage control section.

A fourteenth aspect of the invention is as follows: In the tenth aspect of the invention, the detection voltage value of the standardized characteristic is a value provided in computation of {(reference voltage value of the voltage control section)−(detection voltage value of the characteristic)}×α (where α is a numeric value larger than 0 and equal to or less than 1) in the monitor section.

Accordingly, if the second target voltage value is sufficiently small relative to the value of the reference voltage and the first target voltage value is set almost to the center value of the maximum input-possible voltage range of the voltage control section, control can be performed so that the detection value of the characteristic falls within the vicinity of the center value of the maximum input-possible voltage range of the voltage control section. α is set, whereby an allowance of the upper and lower limits of standardized monitor value input can be provided for the input voltage range of the voltage control section.

A fifteenth aspect of the invention is as follows: In the tenth aspect of the invention, the detection voltage value of the standardized characteristic is a value provided in computation of {(maximum input-possible voltage value of the voltage control section)−(detection voltage value of the characteristic)}×α (where α is a numeric value larger than 0 and equal to or less than 1) in the monitor section.

Accordingly, if the second target voltage value is about a half of the input range of the voltage control section and the detection voltage value of the characteristic is brought close to the second target voltage value, almost the center value of the input voltage range of the voltage control section is the first target voltage value and control can be performed so as to suppress an error of the corresponding standardized monitor value. α is set, whereby an allowance of the upper and lower limits of standardized monitor value input can be provided for the input voltage range of the voltage control section.

A sixteenth aspect of the invention is as follows: In the tenth aspect of the invention, the detection voltage value of the standardized characteristic is a value provided in computation of {(detection voltage value of the characteristic)÷(maximum value of detection voltage of the characteristic)×(maximum input-possible voltage value of the voltage control section)}×α (where α is a numeric value larger than 0 and equal to or less than 1) in the monitor section.

If the second target voltage value exceeds the maximum input-possible voltage value of the voltage control section and is standardized according to the eleventh aspect of the invention, it is also necessary to standardize the detection voltage of the characteristic like the second target voltage value to provide the first target voltage value. According to the invention, if the second target voltage value exceeds the input-possible voltage range of the voltage control section, standardization is executed, whereby the voltage can be controlled. α is set, whereby an allowance of the upper and lower limits of standardized monitor value input can be provided for the input-possible voltage range of the voltage control section.

A seventeenth aspect of the invention is as follows: In the tenth aspect of the invention, detection of the characteristic and the standardization computation are executed using an operational amplifier.

The operational amplifier is thus used, whereby the two functions of monitor of the characteristic and the standardization can be accomplished with one device.

An eighteenth aspect of the invention provides an optical pickup unit wherein the above-described light source drive is installed.

Accordingly, power consumption of the light source drive is suppressed, whereby the time during which power of the battery for operating the light source drive and the optical pickup unit installing the light source drive can be supplied is prolonged, and it is made possible to use the devices for a longer time.

A nineteenth aspect of the invention provides an optical disc drive wherein the above-described optical pickup unit is installed.

Accordingly, power consumption of the light source drive is suppressed, whereby the time during which power of the battery for operating the light source drive and the optical pickup unit and the optical disk drive each installing the light source drive can be supplied is prolonged, and it is made possible to use the devices for a longer time.

A twentieth aspect of the invention provides an information terminal wherein the above-described optical disc drive is installed.

Accordingly, power consumption of the light source drive is suppressed, whereby the time during which power of the battery for operating the light source drive and the optical pickup unit, the optical disk drive, and the information terminal each installing the light source drive can be supplied is prolonged, and it is made possible to use the devices for a longer time.

This application based upon and claims the benefit of priority of Japanese Patent Application No 2008-152607 filed on Aug. 6, 1911 the contents of which are incorporated herein by reference in its entirety.

What is claimed is:

1. A light source drive, having:
a light source;
a light source drive section, driving the light source; and
a voltage conversion section, converting a supply voltage from a battery for supplying power into a supply voltage to the light source drive section,
wherein the voltage conversion section sets the supply voltage from the battery to the light source drive section to a preset initial voltage, and then lowers the voltage to a predetermined voltage at which the light source drive section and the light source are driven, the predetermined voltage being lower than the initial voltage.

2. The light source drive as claimed in claim 1, wherein the voltage conversion section sets the initial voltage and after the light amount of the light source is stabilized, lowers the voltage to the predetermined voltage.

3. The light source drive as claimed in claim 1 wherein the light source drive section contains a light source drive semiconductor device for driving the light source and the predetermined voltage is the sum of the voltage of the light source after set to the initial voltage and the voltage at which the light source drive semiconductor device is driven in an unsaturation area.

4. The light source drive as claimed in claim 1 wherein the voltage conversion section gradually lowers the voltage from the initial value to the predetermined voltage.

5. The light source drive as claimed in claim 1 further comprising:
a light quantity detection section for detecting the light quantity of light emitted from the light source; and
a light quantity control section for controlling the light source drive section so that the light quantity matches a target value based on the detection result of the light quantity detection section, wherein
the light quantity control section stabilizes the light quantity of the light source.

6. The light source drive as claimed in claim 1, wherein the light source drive section contains a light source drive semiconductor device for driving the light source and the light source drive semiconductor device has a characteristic to indirectly know a power loss.

7. The light source drive as claimed in claim 6, wherein the voltage of the light source drive section drives in the range in which the upper limit is a value resulting from adding the difference value between the maximum drive voltage and the minimum drive voltage of the light source and a characteristic value to indirectly indicate the fact that the light source can be driven and the power loss of the light source drive semiconductor device becomes the lowest in a range in which the light source can be driven and the lower limit is a value at which the power loss of the light source drive semiconductor device becomes the lowest.

8. The light source drive as claimed in claim 7, wherein the characteristic value to indirectly indicate the fact that the power loss of the light source drive semiconductor device becomes the lowest is substantially constant in a current range in which the light source can be driven.

9. The light source drive as claimed in claim 7, wherein the light source drive semiconductor device is a transistor, the characteristic to indirectly know the power loss of the light source drive semiconductor device is a collector-emitter voltage of the transistor, and the characteristic value to indirectly indicate the fact that the power loss of the light source drive semiconductor device becomes the lowest is the saturation voltage between the collector and the emitter of the transistor.

10. The light source drive as claimed in claim 6, further having:
a monitor section for detecting the characteristic to indirectly know the power loss of the light source drive semiconductor device and standardizing so that the detected characteristic falls within a value in the input range of the voltage conversion section; and
a voltage control section for controlling a power supply voltage from the voltage conversion section to the light source drive section so that the voltage detected by the monitor section becomes a preset first target voltage value,
wherein the first target voltage value is a standardized value so that a second target voltage value preset for the characteristic to indirectly know the power loss falls within the input range of the voltage control section and the second target voltage value is set equal to or more than the characteristic value to indirectly suggest the fact that the power loss of the light source drive semiconductor device becomes the lowest in the current range in which the light source can be driven and equal to or less than a voltage value resulting from adding the difference value between the maximum drive voltage and the minimum drive voltage of the light source and a characteristic value to indirectly suggest the fact that the light source can be driven and the power loss of the light source drive semiconductor device becomes the lowest in the current range in which the light source can be driven.

11. The light source drive as claimed in claim 10, wherein the first target voltage value is a preset value in computation of {(reference voltage value of the voltage control section) (where the reference voltage value is almost an intermediate value of the maximum input-possible voltage value of the voltage control section)−(the second target voltage value)}×α (where α is a numeric value larger than 0 and equal to or less than 1).

12. The light source drive as claimed in claim 10, wherein the first target voltage value is a preset value in computation of {(maximum input-possible voltage value of the voltage control section)−(the second target voltage value)}×α (where α is a numeric value larger than 0 and equal to or less than 1).

13. The light source drive as claimed in claim 10, wherein the first target voltage value is a preset value in computation of {(the second target voltage value)÷(maximum voltage value of the second target voltage value)×(maximum input-possible voltage value of the voltage control section)}×α (where α is a numeric value larger than 0 and equal to or less than 1).

14. The light source drive as claimed in claim 10, wherein the detection voltage value of the standardized characteristic is a value provided in computation of {(reference voltage value of the voltage control section)−(detection voltage value of the characteristic)}×α (where α is a numeric value larger than 0 and equal to or less than 1) in the monitor section.

15. The light source drive as claimed in claim 10, wherein the detection voltage value of the standardized characteristic is a value provided in computation of {(maximum input-possible voltage value of the voltage control section)−(detection voltage value of the characteristic)}×α (where α is a numeric value larger than 0 and equal to or less than 1) in the monitor section.

16. The light source drive as claimed in claim 10, wherein the detection voltage value of the standardized characteristic is a value provided in computation of {(detection voltage value of the characteristic)÷(maximum value of detection voltage of the characteristic)×(maximum input-possible voltage value of the voltage control section)}×α (where α is a numeric value larger than 0 and equal to or less than 1) in the monitor section.

17. The light source drive as claimed in claim 10 wherein detection of the characteristic and the standardization computation are executed using an operational amplifier.

18. An optical pickup unit wherein the light source drive as claimed in claim 1 is installed.

19. An optical disc drive wherein the optical pickup unit as claimed in claim 18 is installed.

20. An information terminal wherein the optical disc drive as claimed in claim 19 is installed.
